(19) United States
(12) Patent Application Publication
(10) Pub. No.: US 2020/0104911 A1
(43) Pub. Date: Apr. 2, 2020

(54) DYNAMIC MONITORING AND PROFILING OF DATA EXCHANGES WITHIN AN ENTERPRISE ENVIRONMENT

(71) Applicant: The Toronto-Dominion Bank, Toronto (CA)

(72) Inventors: GREGORY SUVAJAC, Toronto (CA); Kai Yee Chan, Toronto (CA); Scott Donald Keith Pearson, Oakville (CA); Cameron Scott Wiginton, Richmond Hill (CA)

(21) Appl. No.: 16/148,399

(22) Filed: Oct. 1, 2018

(51) Int. Cl. G06Q 40/02; G06N 7/00; G06N 3/04

(52) U.S. Cl. CPC G06Q 40/02; G06N 3/04; G06N 7/005

(57) ABSTRACT

The disclosed exemplary embodiments include computer-implemented apparatuses and processes that dynamically monitor and profile exchanges of data between network-connected devices and systems. For example, an apparatus may determine a value of a metric characterizing a probability that a first counterparty performs an exchange of exchange in accordance with at least one parameter value during a future temporal interval. The apparatus may also establish a consistency between a triggering criterion associated with the data exchange and at least one of (i) the metric value, (ii) a change in the metric value, or (iii) interaction data that characterizes an interaction between the first counterparty and a second counterparty to the data exchange. In response to the established consistency, the apparatus may generate and transmit to a device a signal that causes a application program executed by the device to present a representation of the metric value within a digital interface.

### TECHNICAL FIELD

The disclosed embodiments generally relate to computer-implemented systems and processes that dynamically monitor and profile exchanges of data between network-connected devices and systems within an enterprise environment.

### BACKGROUND

Today, consumers are comfortable interacting with financial institutions across channels of digital communication, especially as these consumers continue to integrate technology into aspects of their daily lives. Many financial institutions, however, fail to leverage these digital channels of communication and the potential mechanisms for digital interaction to improve a provisioning of financial services to customers while reducing a risk that results from these provisioned financial services.

### SUMMARY

In some examples, an apparatus includes a communications unit, a storage unit storing instructions, and at least one processor coupled to the communications unit and the storage unit. The at least one processor is configured to execute the instructions to obtain information associated with a first counterparty to an exchange of data. The data exchange is characterized by at least one parameter value, and based the obtained information, the at least one processor is further configured to determine a value of a metric characterizing a probability that the first counterparty performs the data exchange in accordance with the at least one parameter value during a future temporal interval. The at least one processor is also configured to establish a consistency between a triggering criterion associated with the data exchange and at least one of (i) the metric value, (ii) a change in the metric value during a prior temporal interval, or (iii) interaction data that characterizes an interaction between the first counterparty and a second counterparty to the data exchange. Further, and in response to the established consistency, the at least one processor is further configured to generate and transmit, via the communications unit, a first signal to a first device. The first signal includes additional information that causes a first application program executed by the first device to present a representation of the metric value within a corresponding digital interface.

In other examples, a computer-implemented method includes obtaining, by at least one processor, information associated with a first counterparty to an exchange of data. The data exchange is characterized by at least one parameter value, and based the obtained information, the computer-implemented method determines, by the at least one processor, a value of a metric characterizing a probability that the first counterparty performs the data exchange in accordance with the at least one parameter value during a future temporal interval. The computer-implemented method also includes establishing, by the at least one processor, a consistency between a triggering criterion associated with the data exchange and at least one of (i) the metric value, (ii) a change in the metric value during a prior temporal interval, or (iii) interaction data that characterizes an interaction between the first counterparty and a second counterparty to the data exchange. In response to the established consistency, the computer-implemented method generates and transmits, by the at least one processor, a first signal to a first device. The first signal includes additional information that causes a first application program executed by the first device to present a representation of the metric value within a corresponding digital interface.

Additionally, in some examples, a tangible, non-transitory computer-readable medium stores instructions that, when executed by at least one processor, cause the at least one processor to perform a method. The method includes obtaining information associated with a first counterparty to an exchange of data. The data exchange is characterized by at least one parameter value, and based the obtained information, the method determines a value of a metric characterizing a probability that the first counterparty performs the data exchange in accordance with the at least one parameter value during a future temporal interval. The method also includes establishing a consistency between a triggering criterion associated with the data exchange and at least one of (i) the metric value, (ii) a change in the metric value during a prior temporal interval, or (iii) interaction data that characterizes an interaction between the first counterparty and a second counterparty to the data exchange. In response to the established consistency, the method generates and transmits a signal to a device. The signal includes additional information that causes an application program executed by the device to present a representation of the metric value within a corresponding digital interface.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a diagram of an exemplary computing environment, consistent with disclosed embodiments.

FIG. 2 is a diagram illustrating a portion of an exemplary computing environment, consistent with the disclosed embodiments.

FIG. 3A is a diagram illustrating an exemplary multidimensional metric-value coordinate space, consistent with the disclosed embodiments.

FIGS. 3B, 3C, and 3D are diagrams illustrating an exemplary multidimensional risk coordinate space, consistent with the disclosed embodiments.

FIG. 4A is a diagram illustrating a portion of an exemplary computing environment, consistent with the disclosed embodiments.

FIG. 4B is a diagram illustrating an exemplary element of structured exception data, consistent with the disclosed embodiments.

FIG. 4C is a diagram illustrating a portion of an exemplary computing environment, consistent with the disclosed embodiments.

FIGS. 4D and 5 are diagrams illustrating portions of an exemplary graphical user interface, consistent with the disclosed embodiments.

FIG. 6 is a flowchart of an exemplary process for monitoring and profiling exchanges of data within an enterprise environment, consistent with the disclosed embodiments.

### DETAILED DESCRIPTION

Reference will now be made in detail to the disclosed embodiments, examples of which are illustrated in the accompanying drawings. The same reference numbers in the drawings and this disclosure are intended to refer to the same or like elements, components, and/or parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the described subject matter.

### I. Exemplary Computing Environments

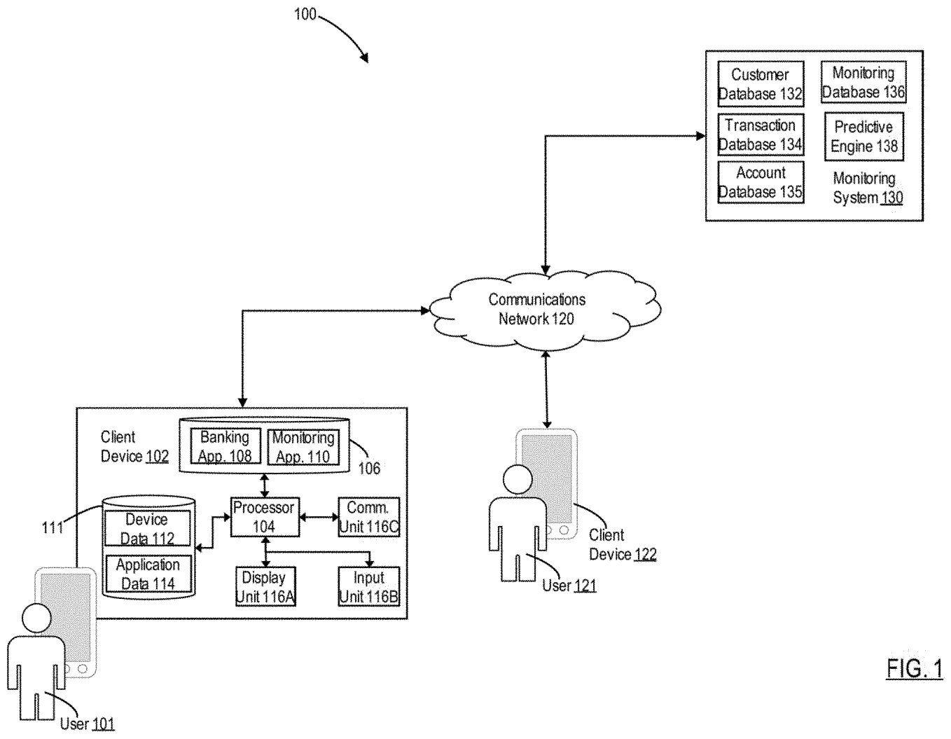

FIG. 1 is a diagram illustrating an exemplary computing environment 100, consistent with certain disclosed embodiments. As illustrated in FIG. 1, environment 100 may include one or more devices, such as client device 102 (e.g., as operated by user 101) and client device 122 (e.g., as operated by user 121), and one or more computing systems, such as monitoring system 130, each of which may be interconnected through any appropriate combination of communications networks, such as network 120. Examples of network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

In some examples, client device 102 may include a computing device having one or more tangible, non-transitory memories that store data and/or software instructions, and one or more processors, e.g., processor 104, configured to execute the software instructions. The one or more tangible, non-transitory memories may, in some instances, store software applications, application modules, and other elements of code executable by the one or more processors, e.g., within application repository 106. For example, as illustrated in FIG. 1, client device 102 may maintain, within application repository 106, one or more executable applications associated with, and provisioned to client device 102 by, monitoring system 130, such as, but not limited to, banking application 108 or monitoring application 110. As described herein, each of banking application 108 and monitoring application 110 may exchange data with monitoring system 130 or other network-connected computing systems operating within environment 100 through one or more secure, programmatic interfaces, such as an application programming interfaces (API), e.g., in support of any of the exemplary processes described herein.

Client device 102 may also establish and maintain, within the one or more tangible, non-tangible memories, one or more structured or unstructured data repositories or databases, e.g., data repository 111, that include device data 112 and application data 114. For example, device data 112 may include data that uniquely identifies client device 102, such as a media access control (MAC) address of client device 102 or an IP address assigned to client device 102, and application data 114 may include information that facilitates a performance of operations by the one or more executable application programs maintained within application repository 106, e.g., banking application 108 and/or monitoring application 110. For instance, application data 114 may include one or more authentication credentials that enable user 101 to access one or more digital interfaces generated by executed banking application 108 and additionally, or alternatively, monitoring application 110, and examples of the one or more authentication credentials include, but are not limited to, an alphanumeric user name or user name, an alphanumeric password, or a biometric authentication credential (e.g., a digital image of user 101′s face, a fingerprint scan, etc.).

Client device 102 may also include a display unit 116A configured to present interface elements to user 101, and an input unit 116B configured to receive input from user 101, e.g., in response to the interface elements presented through display unit 116A. By way of example, display unit 116A may include, but is not limited to, an LCD display unit or other appropriate type of display unit, and input unit 116B may include, but is not limited to, a keypad, keyboard, touchscreen, voice activated control technologies, or appropriate type of input unit. Further, in additional aspects (not depicted in FIG. 1), the functionalities of display unit 116A and input unit 116B may be combined into a single device, e.g., a pressure-sensitive touchscreen display unit that presents interface elements and receives input from user 101. Client device 102 may also include a communications unit 116C, such as a wireless transceiver device, coupled to processor 104 and configured by processor 104 to establish and maintain communications with network 120 using any of the communications protocols described herein.

Examples of client device 102 may include, but are not limited to, a personal computer, a laptop computer, a tablet computer, a notebook computer, a hand-held computer, a personal digital assistant, a portable navigation device, a mobile phone, a smartphone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), and any other type of computing device that may be configured to store data and software instructions, execute software instructions to perform operations, and/or display information on an interface module, consistent with disclosed embodiments. In some instances, user 101 may operate client device 102 and may do so to cause client device 102 to perform one or more operations consistent with the disclosed embodiments.

Further, although not illustrated in FIG. 1, client device 122 may also include a computing device having one or more tangible, non-transitory memories that store data and/or software instructions, and one or more processors configured to execute the software instructions. As described herein, the one or more tangible, non-transitory memories may store software applications, application modules, and other elements of code executable by the one or more processors (e.g., banking application 108 and/or monitoring application 110), and may include one or more structures or structured or unstructured data repositories, such as those described herein that maintain data characterizing client device 122 or user 101 and the executable application programs. It should be understood that, unless otherwise indicated, these and other exemplary components of client device 122 are similar in structure and functionality to those described herein in reference to client device 102. Further, the description of user 101, as set forth below, may also apply to user 121 and to operators of other client devices within environment 100.

Referring back to FIG. 1, monitoring system 130 may represent a computing system that includes one or more servers (not depicted in FIG. 1) and tangible, non-transitory memory devices storing executable code and application modules. Further, the servers may each include one or more processor-based computing devices, which may be configured to execute portions of the stored code or application modules to perform operations consistent with the disclosed embodiments.

In other examples, monitoring system 130 may correspond to a distributed system that includes computing components distributed across one or more networks, such as network 120, or other networks, such as those provided or maintained by cloud-service providers, e.g., Google Cloud™, Microsoft Azure™, etc. In some instances, and as described herein, the distributed computing components of monitoring system 130 may collectively perform operations that establish and maintain one or more cloud-based data repositories that maintain, among other things, data identifying and characterizing one or more counterparties to an exchange of data (e.g., counterparty data) and data identifying and characterizing one or more prior exchanges of data involving the one or more counterparties (e.g., transaction data).

In other instances, also described herein, the distributed computing components of monitoring system 130 may collectively perform additional, or alternate, operations that establish an artificial neural network capable of, among other things, adaptively and dynamically processing portions of the counterparty and/or transaction data to predict a value of a metric characterizing a probability that a corresponding one of the of the counterparties performs the data exchange in accordance with at least one parameter value during a future temporal interval. The disclosed embodiments are, however, not limited to these exemplary distributed systems, and in other instances, monitoring system 130 may include computing components disposed within any additional or alternate number or type of computing systems or across any appropriate network.

By way of example, monitoring system 130 may be associated with, or may be operated by, a financial institution that provides financial services to customers. In one instance, the customers of the financial institution can include one or more individuals (e.g., user 101 or user 121), and the financial institution can provide personal financial services to the one or more individual customers that include, but are not limited to, issuing and maintaining deposit accounts (e.g., checking accounts, savings accounts, etc.), issuing personal credit cards or other personal lines of credit, or underwriting, holding, or services personal loans or mortgages. In other instances, the customers of the financial institution can also include one or more business operating in corresponding jurisdictions and having corresponding corporate structures (e.g., one or more “commercial” customers). As described herein, the financial institution can provide financial services to these commercial customers that include, but are not limited to, issuing and maintaining deposit accounts (e.g., commercial checking accounts), issuing commercial credit cards or revolving lines of credit, providing transactions services (e.g., payment processing), or underwriting, holding, or services commercial loans.

In some instances, the terms that characterize the provided financial services, and a risk to the financial institution that results from the provision of these financial services, can depend not only on an initial credit worthiness of the personal or commercial customers of the financial institution (e.g., at an issuance of a credit card, revolving line of credit, commercial loan, etc.), but also on a subsequent behavior of and additional actions taken by these personal and commercial customers. In some instances, monitoring system 130 can perform any of the exemplary processes described herein to apply one or more predictive models to data that identifies and characterizes the customers of the financial institution, and based on the application of the predictive models, monitoring system can generate a composite metric value indicative of the risk, to the financial institution, resulting from the subsequent behavior of and additional actions taken by each of the one or more customers.

Monitoring system 130 may also perform operations that parameterize a risk profile for each of the one or more customers based not only on the corresponding predicted value of the composite metric, but also on a derived temporal variation in each of the predicted values of the composite metric and additionally, or alternatively, on values of other parameters that characterize the customers, the financial services provided to the customers, or a relationship between the customers and the financial institution. In some instances, as described herein, the parameterized risk profile for a corresponding one of the customers, such as a commercial customer of the financial institution, can trigger an automatic performance, by monitoring system 130 of one or more operations associated with the commercial customer or the financial services provided to that commercial customer. Examples of these triggered operations can include, but are not limited to, a generation and a delivery of a programmatic notification to one or more network-connected devices or systems operating within environment 100, such as client devices 102 or 122, or a dynamically review or modification of the terms that characterize the provided financial services.

To facilitate the performance of any of the exemplary processes described herein, monitoring system 130 may maintain, within one or more tangible, non-transitory memories, a customer database 132, a transaction database 134, an account database 135, and a monitoring database 136. By way of example, customer database 132 may include data records that identify and characterize users of one or more native application programs associated with, or supported by, monitoring system 130, such as banking application 108 executed by client devices 102 or 122. In some instances, each of these users may correspond to a customer of the financial institution that operates monitoring system 130, which may provide any of the exemplary banking, lending, or financial services to these customers.

In some examples, the data records of customer database 132 may include, for each of the users, a corresponding user identifier (e.g., an alphanumeric login name associated with executed monitoring application 110) and a corresponding unique device identifier associated with each network-connected device or system operated by that user (e.g., an IP address, a MAC address, a mobile telephone number, etc.). Further, and as described herein, the data records of customer database 132 may also maintain information that identifies and characterizes each of the customers of the financial institution that operates monitoring system 130, such as, but not limited to, the individual and commercial customers described herein. For example, and for a particular one of the customers, the data records of customer database 132 may include a unique identifier of the customer (e.g., a customer name, an alphanumeric customer identifier, etc.), data specifying a physical address of the customer, and profile data that characterizes the customer and a relationship between the customer and the financial institution.

By way of example, and as described herein, the customers of the financial institution may include one or more individual customers, such as user 101 or user 121. In some instances, and for each of these individual customers, the profile data maintained within customer database 132 may include, but is not limited to, values of demographic parameters that characterize the individual customer (e.g., an age, a gender, an occupation, a family structure, etc.) and information characterizing a current or historical relationship between that customer and the financial institution.

In other examples, also described herein, the customers of the financial institution may include one or more commercial customers, and the profile data maintained within customer database 132 may include, for each of the commercial customers, information that identifies a current or historical organizational structure of that commercial customer (e.g., an incorporated entity, a limited-liability partnership, etc.) and a jurisdiction in which the commercial customer is incorporated or registered. The profile data for each of the commercial customers may also identify and characterizing various operations performed by the commercial customer, e.g., as specified by a four-digit, standard industrial classification (SIC) code assigned to or associated with that particular commercial customer and additionally, or alternatively, a financial position of the commercial customer. For instance, and for a particular one or the commercial customers, the profile data may include, among other things, data characterizing earnings, assets, liabilities, or net (or gross) sales of the particular commercial customers across one or more reporting periods (e.g., based on quarterly reports, yearly reports, or tax returns generated for submission to one or more governmental or regulatory entities).

Further, and as described herein, one or more of the users of banking application 108, e.g., user 101 or user 121, may be associated with, may represent, or may be employed by one or more of the commercial customers of the financial institution. In some instances, the data records of the customer database 132 may associate or link the information identifying each of these users (e.g., the user and device identifiers described herein) to corresponding elements of commercial customer data 132A, as described herein. The disclosed embodiments are, however, not limited to these examples of customer-specific data, and in other instances, the data records of customer database 132 may include any additional or alternate elements of the profile data described herein, and further, any additional or alternate information capable of identifying or characterizing the individual or commercial customers of the financial institution.

Referring back to FIG. 1, transaction database 134 may include data records that identify and characterize one or more exchanges of data initiated by, or on behalf of, one or more users of monitoring system 130 during prior temporal intervals. For example, and for a corresponding one of the initiated data exchanges, the data records of transaction database 134 may include, but are not limited to, a unique identifier of the initiated data exchange, data that identifies the initiating user, device, or customer (e.g., the login credential of user 101, the device identifier of client device 102, one of the customer identifiers described herein, etc.), an initiation time or date, and values of one or more parameters that characterize the corresponding one of the initiated data exchanges, as described herein.

By way of example, one or more of the initiated exchanges of data may correspond to a purchase transaction involving a payment instrument (e.g., a credit card account, a debit card account linked to an underlying deposit account, etc.) issued to a commercial customer of the financial institution that operated monitoring system. In some instances, the data records of transaction database 134 may maintain, for the initiated purchase transaction, parameter values that include an identifier of the payment instrument (e.g., a portion of a tokenized account number, etc.), a transaction amount, a transaction date or time, a counterparty identifier (e.g., a merchant name or identifier), and data indicative of a purchased product or service (e.g., a universal product code (UPC), etc.).

In other examples, one or more of the initiated exchanges of data may facilitate an issuance of a revolving line of credit, a commercial loan, a payment instrument or other financial, credit, or payment instrument to a commercial customer of the financial institution that operates monitoring system 130. In some instances, the data records of transaction database 134 may include, for each of the issued financial, credit, or payment instruments, data that identifies the financial, credit, or payment instrument, a time or date of issuance, and a value of one or more parameters that characterize the financial, credit, or payment instrument, such as, but not limited to, an amount of available credit or a corresponding repayment schedule.

Further, in some examples, one or more of the initiated exchanges of data may also correspond to a transaction initiated by a commercial customer in furtherance of a repayment schedule associated with any of the financial, credit, or payment instruments described herein, e.g., as issued by the financial institution that operates monitoring system 130 or by other financial institutions. For instance, the data records of transaction database 134 may include, for each of these repayment transactions, a corresponding transaction identifier, a transaction amount, a transaction data or time, an identifier of the corresponding one of the financial, credit, or payment instruments associated with the repayment transaction, and data characterizing a repayment schedule for the corresponding one of the financial, credit, or payment instruments, such as, but not limited to, an expected repayment data or an expected repayment amount, e.g., a minimum payment, etc.

In one instance, all or a portion of the data maintained within transaction database 134 may be generated by monitoring system 130 (e.g., through processes that provision the commercial banking or other financial services to the one or more customers). In other instances, and consistent with the disclosed exemplary embodiments, monitoring system 130 may receive all or a portion of the data maintained within transaction database 134 from one or more external computing systems through a corresponding programmatic interface, such as, but not limited to, an external computing system that stablishes or maintains a cloud-based storage facility. Further, the data records of transaction database 134 are not limited to the exemplary elements of transaction data described herein, and in other instances, transaction database 134 may include any additional or alternate elements of data characterizing exchanges of data between, or involving, the financial institution that operates monitoring system 130 or the customers of that financial institution, e.g., the commercial or individual customers described herein.

Referring back to FIG. 1, account database 135 may include data records that identify and characterize one or more payment instruments, credit instruments, or other financial institutions provisioned to the customers of the financial institution. For example, and for the commercial customer described herein, the payment instruments may include, but are not limited to, a commercial credit card, and the credit instruments may include, but are not limited to, a revolving line-of-credit or a commercial loan. Further, and for each of the provisioned payment or credit instruments, the data records of account database 135 may include a unique identifier, such as a portion of a tokenized account number, data that identifies a current status, such as a current balance or an amount of principal, or data that establishes one or more terms or conditions, such as a repayment schedule or an interest rate.

Further, monitoring database 136 may include one or more data records that, when accessed and processed by monitoring system 130, facilitate or support the performance of any of the exemplary processes described herein. For example, the data records of monitoring database 136 may support the calculation of one or more metrics indicative of a financial risk to a financial institution that results from the provision of the commercial banking or other financial services to corresponding individual or commercial customers, e.g., based on an application of one or more statistical processes, machine learning processes, or artificial intelligence processes to portions of the data records maintained within customer database 132 and transaction databases 134. In other examples, the data records of monitoring database 136 may include information that specifies and characterizes one or more segmentation models that, when implemented by monitoring system 130, facilitate a determination of a risk profile characterizing one or more of the individual or commercial customers, and a performance of additional operations consistent with the determined risk profiles.

Further, as illustrated in FIG. 1, monitoring system 130 may also maintain, within the one or more tangible, non-transitory memories, one or more executable application programs, such as a predictive engine 138. For example, when executed by monitoring system 130, predictive engine 138 may apply one or more predictive models to portions of the exemplary customer, transaction, and account data described herein (e.g., as maintained within customer database 132, transaction database 134, and account database 135). Based on the application of the one or more predictive models, executed predictive engine 138 may compute, for one or more of the customers of the financial institution (e.g., as identified within customer database 132), a value of composite metric that indicates a probability that a corresponding one of the customers performs an expected exchange of data in accordance with an expected parameter value during a corresponding and future temporal interval. As described herein, the performance of the data exchange may, in some examples, facilitates a servicing of one or more existing obligations imposed on that corresponding customer by the financial institution (e.g., a scheduled payment on a revolving line of credit or a loan provided to the customer by the financial institution), and the computed value of composite metric may be indicative of a risk to the financial institution that results from the provision of the financial services to that corresponding customer.

As described herein, executed predictive engine 138 may perform operations that derive the value of composite metric for the each of the customers of the financial institution based on values of a plurality of component metrics. By way of example, for a commercial customer of the financial institution, the component metrics may characterize a risk to the financial institution that results from, among other things, a location, structure, or operations of the commercial customer (e.g., a general metric), a current or historical financial position or status of the commercial customer (e.g., a financial metric), or an interaction between the commercial customer and the financial institution during the provisioning of any of the exemplary financial services described herein (e.g., a behavioral metric).

In some instances, predictive engine 138 may compute a value for the general metric, the financial metric, and additionally, or alternatively, based on an application of one or more deterministic or stochastic statistical processes, one or more machine learning processes, or one or more artificial intelligence models to portions of the exemplary customer and transaction data described herein, e.g., as maintained within customer database 132, transaction database 134, and account database 135. For example, the deterministic algorithms can include, but are not limited to, a linear regression model, a nonlinear regression model, a multivariable regression model, and additionally, or alternatively, a linear or nonlinear least-squares approximation.

Examples of the stochastic statistical processes can include, among other things, a support vector machine (SVM) model, a multiple regression algorithm, a least absolute selection shrinkage operator (LASSO) regression algorithm, or a multinomial logistic regression algorithm, and examples of the machine learning processes can include, but are not limited to, an association-rule algorithm (such as an Apriori algorithm, an Eclat algorithm, or an FP-growth algorithm) or a clustering algorithm (such as a hierarchical clustering process, a k-means algorithm, or other statistical clustering algorithms). Further, examples of the artificial intelligence models include, but are not limited to, an artificial neural network model, a recurrent neural network model, a Bayesian network model, or a Markov model. In some instances, these stochastic statistical processes, machine learning algorithms, or artificial intelligence models can be trained against, and adaptively improved using, training data having a specified composition, which may be extracted from portions of customer database 132 and transaction database 134 along with corresponding outcome data, and can be deemed successfully trained and ready for deployment when a model accuracy (e.g., as established based on a comparison with the outcome data), exceeds a threshold value.

Further, and as described herein, executed predictive engine 138 may also perform operations that determine the value for the composite metric for each of the customers of the financial institution based on combination of one or more of the component metric values, e.g., one or more of the general metric value, the financial metric value, and the behavioral metric value. For example, executed predictive engine 138 may generate the composite metric value based on a linear combination of the general metric value, the financial metric value, and the behavioral metric value (e.g., a simple or a weighted average, etc.) or a nonlinear combination of the general metric value, the financial metric value, and the behavioral metric value (e.g., a geometric average, etc.). In other examples, executed predictive engine 138 may generate the composite metric value based on an application a regression model to one, or more, of the general metric value, the financial metric value, and the behavioral metric value (e.g., a multivariable regression model, etc.). The disclosed embodiments are, however, not limited to these exemplary processes for computing the component metric values, or for computing the composite metric value based on all or a portion of these components values, and in other examples, executed predictive engine 138 may compute the component metric values, or the composite metric value, using any additional or alternate processes appropriate to the elements of input customer or transaction data, including those exemplary statistical processes, machine learning processes, or artificial intelligence models described herein.

Executed predictive engine 138 may also perform operations that parameterize a risk profile for each of the one or more customers based not only on the corresponding predicted value of the composite metric, but also on a derived temporal variation in each of the predicted values of the composite metric and additionally, or alternatively, on values of other parameters that characterize the customers, the financial services provided to the customers, or a relationship between the customers and the financial institution. In some instances, as described herein, the parameterized risk profile for a corresponding one of the customers, such as a commercial customer of the financial institution, can trigger an automatic performance, by monitoring system 130 of one or more operations associated with the commercial customer or the financial services provided to that commercial customer. Examples of these triggered operations can include, but are not limited to, a generation and a delivery of a programmatic notification to one or more network-connected devices or systems operating within environment 100, such as client devices 102 or 122, or a dynamic review or modification of the terms that characterize the provided financial services.

II. Exemplary Computer-Implemented Processes for Dynamically Monitoring and Profiling Exchanges of Data within an Enterprise Environment

In some exemplary embodiments, a network-connected computing system, such as monitoring system 130 of FIG. 1, may access contextual data that identifies and characterizes one or more initiated or expected exchanges of data involving a first counterparty and one or more second counterparties. The accessed contextual data may, for instance, specify values of parameters that characterize the initiated or expected data exchanges, along with additional data characterizing the first counterparties and an interaction between the first counterparties and each of the one or more second counterparties. Further, and based on an application of one or more predictive models to selected portions of the accessed contextual data, monitoring system 130 may perform any of the exemplary processes described herein to compute a value of a metric that characterizes a likelihood that the first counterparty will perform one, or more, of the expected data exchanges in accordance with corresponding one of the parameter values (e.g., “expected” parameter values) during a future temporal interval.

The computed metric value may, in some instances, represent a composite metric value, which monitoring system 130 derives from a plurality of components values computed based an application of corresponding ones of the predictive models to the selected portions of the accessed contextual data. Further, and as described herein, the one or more predictive models may include, among other things, a deterministic statistical process, a stochastic statistical process, a machine learning process, or an artificial intelligence model (or any combination thereof), and monitoring system 130 may perform operations that apply the one or more predictive models to the selected portions of the accessed contextual data, and that compute the metric value, at regular or predetermined intervals (e.g., daily, weekly, monthly, etc.).

In some instances, monitoring system 130 may obtain monitoring data that specifies or identifies at least one triggering criterion associated with the one or more expected data exchanges, e.g., as maintained within monitoring database 136 of FIG. 1. As described herein, monitoring system 130 may perform operations that establish a consistency between the at least one triggering criterion and the computed metric value, taken individually or in combination with (i) a determined temporal evolution in the computed metric value over one or more prior temporal intervals and (ii) a portion of the accessed contextual data that characterizes an interaction between the first and second counterparties (e.g., “interaction” data).

Based on the established consistency, monitoring system 130 may perform further operations that include, but are not limited to, dynamically modifying at one or more of the expected parameter values that characterize the expected data exchanges, or generating and transmitting a signal that includes the computed metric value (and additionally, or alternatively, the temporal evolution of the computed metric value or the interaction data) to a device operated by at least one of the first or second counterparties. As described herein, the generated and transmitted signal may include information that causes an application program executed by the device (e.g., banking application 108 or monitoring application 110 of FIG. 1) to present a representation of the computed metric value, the temporal evolution of the computed metric value, and additionally, or alternatively, the interaction data, within a corresponding digital interface.

In one example, and as described herein, monitoring system 130 can be associated with, or operated by, a financial institution that provides financial services of one or more individual or commercial customers. For instance, the first counterparty may correspond to a commercial customer of the financial institution, which can provide commercial financial services that include, but are not limited to, issuing and maintaining deposit accounts (e.g., commercial checking accounts), issuing commercial credit cards or revolving lines of credit, providing transactions services (e.g., payment processing), or underwriting, holding, or services commercial loans. Further, in some instances, the initiated or expected exchanges of data (e.g., that involve the first counterparty) can facilitate a provisioning by the financial institution of one or more of these commercial financial services to the commercial customer, and the servicing of these provisioned financial serviced by the commercial customer, in accordance with certain parameter values, e.g., terms of the provisioned financial services.

As described herein, the terms that characterize the provisioned financial services, and a risk to the financial institution that results from the provision of these financial services, can depend not only on an initial credit worthiness of the commercial customer (e.g., at an issuance of a credit card, revolving line of credit, commercial loan, etc.), but also on a subsequent behavior of and additional actions taken by the commercial customer. In some instances, the accessed contextual data can identify and characterize not only the commercial customer, the provisioned financial services, and the terms that characterize the provisioned financial services, but also the subsequent behavior of and the additional actions taken by the commercial customer, and the dynamically computed metric value may be indicative of an ongoing risk, to the financial institution that provisions the financial services to the commercial customer, that results from the subsequent behavior of and additional actions taken by each of the one or more customers.

Monitoring system 130 may also perform operations that parameterize a risk profile for the commercial customer based not only on the computed metric value, but also on a derived temporal variation in the computed metric value and additionally, or alternatively, on portions of the accessed contextual data that characterize the commercial customer, the financial services provisioned to the commercial to the customers, or a relationship between the commercial customer and the financial institution (e.g., the second counterparty described herein). In some instances, when consistent with at least one triggering criterion, the parameterized risk profile for the commercial customer can trigger an automatic performance, by monitoring system 130 of one or more operations associated with the commercial customer or the financial services provided to that commercial customer, such as, but not limited to, a generation and a delivery of a programmatic notification to one or more network-connected devices or systems operating within environment 100, such as client devices 102 or 122, or a dynamic review or modification of the terms that characterize the provided financial services.

Using any of the exemplary processes described herein, monitoring system 130 can dynamically and adaptively monitor a risk to a financial institution that results from a provisioning of certain services to a customer, can parameterize a risk profile for that customer based not only on a dynamically predicted value of a metric indicative of that risk, but also on a temporal evolution of that predicted metric value across one or more prior temporal intervals, and further, can dynamically trigger a performance of certain operations based on a detected consistency between the parameterized risk profile and at least one triggering criterion associated with the financial institution or the provisioned financial services. Certain of these exemplary, exception-based monitoring processes can be implemented in addition to, or as an alternate to, conventional processes that monitor risk for customers on a continuous basis during corresponding review periods and perform operations in response to the monitored risk upon conclusion of these review periods.

Certain of these exemplary, exception-based monitoring processes may also improve a speed and an efficiency at which monitoring system 130 monitors and acts upon the risk associated with the provision of financial services to customers, as these exception-based processes dynamically and selectively trigger the performance of operations based on the detected consistency between the at least one triggering criterion and the parameterized risk profiles of these customers, and not automatically for each monitored customer at a conclusion of the fixed and predetermined review period. Further, by applying one or more stochastic statistical processes, machine learning processes, or artificial intelligence models to portions of the accessed contextual data, certain of these exemplary exception-based monitoring processes can leverage and dynamically process elements of contextual data maintained in cloud-based storage or distributed data lakes in a manner not possible using conventional or human-implemented assessment processes.

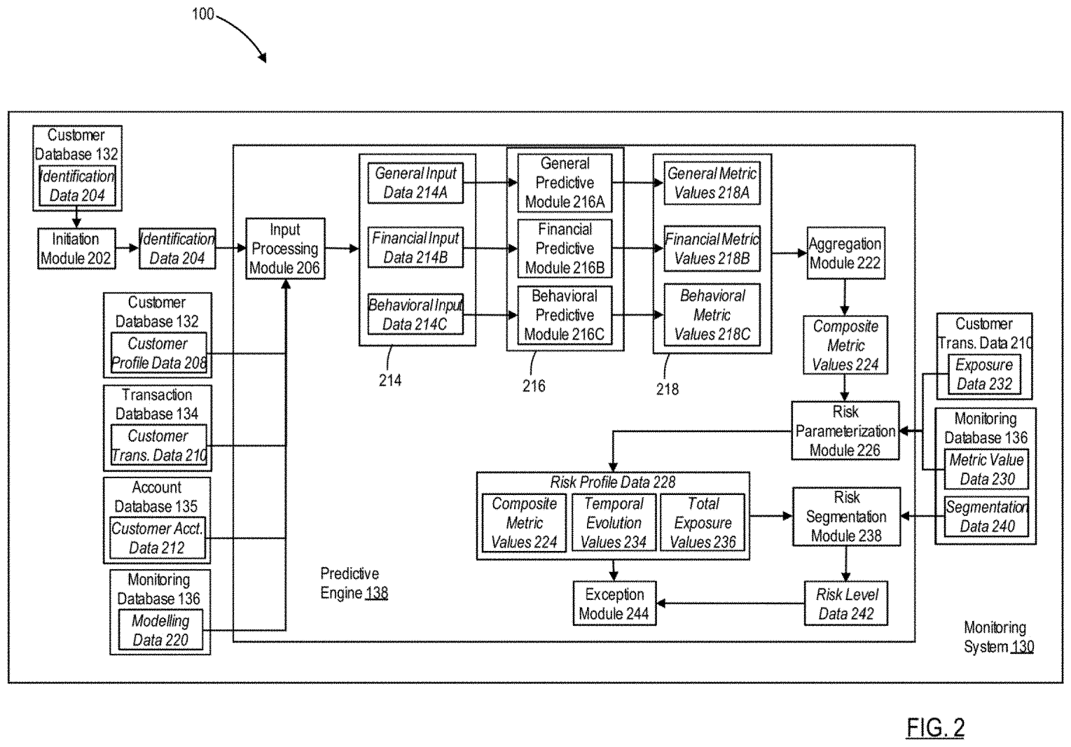

Referring to FIG. 2, an initiation module 202 of monitoring system 130 may perform operations that identify one or more customers of a financial institution or other business entity associated with monitoring system 130, such as, but not limited to, the individual or commercial customers of the financial institution described herein. In some instances, each of the customers may be associated with, and uniquely identified by, a corresponding customer identifier, and examples of these customer identifiers include, but are not limited to, an alphanumeric login name assigned to an individual customer or to an employee, representative, or other agent of a commercial customer (e.g., that facilitates a secure access to banking application 108), a device identifier associated with a network-connected device operated by an individual customer or by an employee, representative, or other agent of a commercial customer, or an alphanumeric identifier assigned to one or more of the commercial customers. Further, initiation module 202 may identify the one or more customers, and may initiate the performance of the exemplary, exception-based monitoring processes described herein, at regular or predetermined intervals (e.g., daily, weekly, monthly, etc.) or in response to a detected occurrence of certain events, such as, but not limited to, a detected breach by a malicious third party or a request received from an external computing system operated by a regulator or a governmental entity.

By way of example, and as illustrated in FIG. 2, initiation module 202 may access data records maintained within customer database 132, and extract identification data 204 associated with each of the customers of the financial institution or alternatively, associated with a subset of the customers of the financial institution that are subject to monitoring using any of the exemplary, exception-based monitoring processes described herein, e.g., one or more of the commercial customers of the financial institution.

In some instances, identification data 204 may include one or more of the customer identifiers associated with assigned to all, or a portion, of the customers of the financial institution (e.g., the alphanumeric customer identifier, the alphanumeric login name, the device identifier, etc.). Further, and as described herein, the one or more customer identifiers may also be linked to additional elements of customer-specific profile data maintained within customer database 132, to elements of customer-specific transaction data maintained within transaction database 134 (e.g., which identify and characterize one or more exchanges of data initiated by, or on behalf of, corresponding ones of the customers during prior temporal intervals), and to elements of customer-specific account data maintained within account database 135 (e.g., which identify and characterize financial services provisioned to the customers). The disclosed embodiments are, however, not limited to these exemplary elements of identification data 204, and in other instances, identification data 204 may include any additional or alternate data that identifies or characterizes all, or a subset, of the customers of the financial institution, such as, but not limited to, data characterizing a parameterized risk profile for one or more of the customers, e.g., as generated by monitoring system 130 during a prior temporal interval.

As illustrated in FIG. 2, initiation module 202 may provide identification data 204 as an input to predictive engine 138 of monitoring system 130, which may perform operations that compute, for each of the identified customers, a value of metric indicative of a likelihood that the customer performs an expected exchange of data in accordance with an expected parameter value during a corresponding and future temporal interval. As described herein, the performance of the expected data exchange may, in some examples, facilitate a servicing of one or more existing obligations imposed on a corresponding one of the customers by the financial institution (e.g., a scheduled payment on a revolving line of credit or a loan provided to the customer by the financial institution), and the metric value computed for each of the customers may be indicative of a risk to the financial institution that results from the provision of the financial services to the each of the customers.

As illustrated in FIG. 2, predictive engine 138 may include an input processing module 206 that receives identification data 204, and parses identification data 204 to obtain each of the customer identifiers. In some instances, input processing module 206 may access customer database 132, transaction database 134, and account database 135, and extract portions of the maintained customer, transaction, and account data that are linked to, and associated with, each of the obtained customer identifiers included within identification data 204.

By way of example, input processing module 206 may extract, from the data records of customer database 132, one or more elements of customer profile data 208 that are associated with, or linked to, each of the customer identifiers obtained from identification data 204 and as such, that characterize a corresponding one of the individual or commercial customers of the financial institution. For instance, one of the obtained customer identifiers may be associated with a commercial customer of the financial institution, and the one of more extracted elements of customer profile data 208 may include information that identifies a current or historical organizational structure of the commercial customer (e.g., an incorporated entity, a limited-liability partnership, etc.) and a jurisdiction in which the commercial customer is incorporated or registered.

Further, and for the commercial customer, the one of more extracted elements of customer profile data 208 may also identify and characterize an industry within which the commercial customer operates, e.g., as specified by a four-digit, standard industrial classification (SIC) code, and additionally, or alternatively, a financial position of the commercial customer. For instance, and for the commercial customer, the extracted elements of customer profile data 208 may include, among other things, data characterizing earnings, assets, liabilities, or net (or gross) sales of the particular commercial customers across one or more reporting periods (e.g., based on quarterly reports, yearly reports, or tax returns generated for submission to one or more governmental or regulatory entities). Additionally, in some instances, the extracted elements of customer profile data 208 may also include information that identifiers one or more employees, representatives, or agents of the commercial customers, such as, but not limited to, the alphanumeric login name of user 101 or the unique device identifier of client device 102.

In other examples, illustrated in FIG. 2, input processing module 206 may extract, from the data records of transaction database 134, one or more elements of customer transaction data 210 that are associated with, or linked to, each of the customer identifiers obtained from identification data 204 and as such, that are associated with corresponding ones of the individual or commercial customers of the financial institution. In some instances, and for the commercial customer of the financial institution described herein, the one or more extracted elements of customer transaction data 210 may identify and characterize one or more exchanges of data initiated by, or on behalf of, that commercial customer during prior one or more temporal intervals. Further, the one or more extracted elements of customer transaction data 210 may include, for each of the initiated data exchanges involving the commercial customer, a unique identifier of the initiated data exchange, data that identifies the initiating user, device, or customer (e.g., the commercial customer), an initiation time or date, and values of one or more parameters that characterize the corresponding one of the initiated data exchanges.

By way of example, one or more of the initiated exchanges of data may correspond to a purchase transaction involving a payment instrument (e.g., a credit card account, a debit card account linked to an underlying deposit account, etc.) issued to the commercial customer by the financial institution. In some instances, the extracted elements of customer transaction data 210 may specify for the initiated purchase transaction, parameter values that include an identifier of the payment instrument (e.g., a portion of a tokenized account number, etc.), a transaction amount, a transaction date or time, a counterparty identifier (e.g., a merchant name or identifier), and data indicative of a purchased product or service (e.g., a universal product code (UPC), etc.).

In other instances, one or more of the initiated exchanges of data may facilitate an issuance of a revolving line of credit, a commercial loan, a payment instrument or other financial, credit, or payment instrument to the commercial customer by the financial institution. The extracted elements of customer transaction data 210 may include, for each of the issued financial, credit, or payment instruments, data that identifies the financial, credit, or payment instrument, a time or date of issuance, and a value of one or more parameters that characterize the financial, credit, or payment instrument, such as, but not limited to, an amount of available credit or a corresponding repayment schedule.

One or more of the initiated data exchanges may also correspond to a transaction initiated by the commercial customer in furtherance of a repayment schedule associated with any of the financial, credit, or payment instruments described herein. In some instances, the extracted elements of customer transaction data 210 may include, for each of these repayment transactions, a corresponding transaction identifier, a transaction amount, a transaction data or time, an identifier of the corresponding one of the financial, credit, or payment instruments associated with the repayment transaction, and data characterizing a repayment schedule for the corresponding one of the financial, credit, or payment instruments, such as, but not limited to, an expected repayment data or an expected repayment amount, e.g., a minimum payment, etc.

Further, and as illustrated in FIG. 2, input processing module 206 may also extract, from the data records of account database 135, one or more elements of customer account data 212 that are associated with, or linked to, each of the customer identifiers obtained from identification data 204. In some instances, the extracted elements of customer account data 212 may identify and characterize one or more payment instruments (e.g., a credit card, etc.), credit instruments (e.g., a revolving line of credit, a commercial loan, etc.), or other financial instruments (e.g., deposit accounts, etc.) issued by the financial institution to each of the customers associated with the obtained customer identifiers.

For example, the extracted elements of customer account data 212 may include data identifying each of the payment, credit, or financial instruments (e.g., a tokenized account number, etc.), along with additional status data characterizing each customer's current or prior use or interaction with the payment, credit, or financial instruments. The additional status data may identify, for each of the payment, credit, or financial instruments, a current and historical balance of available funds (e.g., a balance history), fees incurred by through the use of the payment, credit, or financial instruments (e.g., an amount and assessment date of expected fees, overdraft fees, negative-balance fees, etc.), a time or date of any overdraft (e.g., for a deposit account) or a negative balance (e.g., a revolving line of credit), and a time or date of any delinquencies (e.g., exceeding an available balance, a late or insufficient payment, etc.).

The disclosed embodiments are, however, not limited to these examples of customer-specific profile, transaction, or account data. In other instances, the extracted elements of customer profile data 208, customer transaction data 210, and customer account data 212 may include any additional, or alternate, information that characterizes the commercial customer described herein and the interaction of that commercial customer with the financial institution or with payment, credit, of financial instruments issued by that financial institution. Further, the disclosed embodiments are also not limited to elements of customer profile, transaction, or account data that characterize commercial customers of the financial institution, and in some instances, the extracted elements of customer profile data 208, customer transaction data 210, and customer account data 212 may also identify and characterize one or more individual customers of the financial institution (e.g., users 101 or 121 of FIG. 1), and an interaction of the one or more individual customers with the financial institution or with payment, credit, or financial instruments.

Based on the extracted elements of customer profile data 208, customer transaction data 210, and customer account data 212, input processing module 206 may generate discrete elements of input data 214 for provisioning to corresponding ones of a plurality of predictive modules 216 of predictive engine 138. In some instances, predictive modules 216 may apply one or more predictive models to the discrete elements of input data 214, and based on the application of these one or more predictive models, predictive modules 216 may perform operations that predict a corresponding one of a plurality of component metric values 218 for each of the customers of the financial institution identified within the discrete elements of input data 214. As described herein, an aggregated risk to the financial institution resulting from the provisioning of financial services to the each of these customers (e.g., as specified within identification data 204 and as identified within input data 214) may depend on multiple, customer-specific risk factors, and each of predicted component metric values 218 may characterize a portion of the aggregated risk that results from corresponding ones of these customer-specific risk factors.

For example, and as described herein, the extracted elements of customer profile data 208, customer transaction data 210, and customer account data 212 may be associated with one or more commercial customers of the financial institution (and may be associated with, or include, corresponding customer identifiers). In some instances, the aggregated risk to the financial institution due to the provisioning of commercial financial services to these commercial customers may depend on risk factors that include, but are not limited to: (i) a location, structure, or operations of each of the commercial customers (e.g., a general risk factor); a current or historical financial position or status of each of the commercial customers (e.g., a financial risk factor); and an interaction between each of the commercial customers and the financial institution during the provisioning of any of the exemplary commercial financial services described herein (e.g., a behavioral risk factor). As illustrated in FIG. 2, and to facilitate a prediction of the plurality of component metric values 218 that characterize respective ones of the general, financial, and behavioral risk factors, predictive modules 216 may include, but are not limited to, a general predictive module 216A that predicts a general metric value 218A characterizing the general risk factor for each of the customers, a financial predictive module 216B that predicts a financial metric value 218B characterizing the financial risk factor for each of the customers, and a behavioral predictive module 216C that predicts a behavioral metric value 218C characterizing the behavioral risk factor for each of the customers.

In some instances, as illustrated in FIG. 2, general predictive module 216A, financial predictive module 216B, and behavioral predictive module 216C may apply one or more predictive models to corresponding ones of model-specific input data 214A, 214B, and 214C (e.g., that collective establish input data 214). Based on the application of these predictive models, general predictive module 216A, financial predictive module 216B, and behavioral predictive module 216C may predict corresponding ones of general metric value 218A, financial metric value 218B, behavioral metric value 218C for each of the customer identifiers included within identification data 204.

As described herein, the one or more predictive models applied by each of general predictive module 216A, financial predictive module 216B, and behavioral predictive module 216C may include, but are not limited to, a deterministic statistical process, a stochastic statistical process, a machine learning process, or an artificial intelligence model. For example, the deterministic statistical processes can include, but are not limited to, an index based on certain parameter values, a linear regression model, a nonlinear regression model, a multivariable regression model, and additionally, or alternatively, a linear or nonlinear least-squares approximation. Examples of the stochastic statistical process can include, among other things, a support vector machine (SVM) model, a multiple regression algorithm, a least absolute selection shrinkage operator (LASSO) regression algorithm, or a multinomial logistic regression algorithm, and examples of the machine learning processes can include, but are not limited to, an association-rule algorithm (such as an Apriori algorithm, an Eclat algorithm, or an FP-growth algorithm) or a clustering algorithm (such as a hierarchical clustering process, a k-means algorithm, or other statistical clustering algorithms). Further, examples of the artificial intelligence model include, but are not limited to, an artificial neural network model, a recurrent neural network model, a Bayesian network model, or a Markov model.

As illustrated in FIG. 2, input processing module 206 may access monitoring database 136, and may extract a first portion of modelling data 220 that specifies the one or more predictive models applied by general predictive module 216A to predict general metric value 218A, and that also specifies certain elements of input data associated with the one or more predictive models (e.g., parameter values extracted or derived from customer profile data 208, customer transaction data 210, and customer account data 212). By way of example, and without limitation, the first portion of modelling data 220 may specify that general metric value 218A represents a general index value computed based on elements of input data that include, but are not limited to, a jurisdiction in which a commercial customer operated or is incorporated, a standard industrial classification (SIC) code assigned to the commercial customer, or a duration of a relationship between the commercial customer and the financial institution. The accessed first portion of modelling data 220 may also include information that facilitates a prediction of general metric value 218A based on the customer-specific, general input data, e.g., information specifying a linear, non-linear, or geometric combination of the elements of general input data and a corresponding normalization scheme.

In some instances, input processing module 206 may perform operations that parse the first portion of modelling data 220 to identify those elements of general input data associated with general predictive module 216A (e.g., the jurisdictional data, the SIC code, and the relationship duration), and may obtain the identified elements of general input data from customer profile data 208 (e.g., and additionally, or alternatively, from portions of customer transaction data 210 or customer account data 212). Input processing module 206 may package the obtained elements of general input data and corresponding customer identifiers into portions of input data 214A, which input processing module 206 may provide as an input to general predictive module 216A. In some examples, general predictive module 216A may process portions of input data 214A in accordance with the first portion of modelling data 220, and may compute the general index value associated with each of the customers specified within input data 214A (e.g., as associated with corresponding customer identifiers). General predictive module 216A may associate each of the general index values with a corresponding one of the customer identifiers, and package the general index values and the associated customer identifiers within general metric values 218A (e.g., which establishes an array of associated general index values and customer identifiers).

Further, input processing module 206 may also extract, from monitoring database 136, a second portion of modelling data 220 that specifies the one or more predictive models applied by financial predictive module 216B to predict financial metric values 218B, and that also specifies certain elements of input data (e.g., “financial input data”) associated with the one or more predictive models. By way of example, and without limitation, the second portion of modelling data 220 may specify that financial metric value 218B represents a financial index value computed based on elements of financial input data that include, but are not limited to, current or historical sales data for a commercial customer (e.g., sales volume, an aggregate value, a growth in a value of volume of sales over multiple temporal intervals, etc.), data characterizing assets held by the commercial customer (e.g., types of assets, values of the assets, etc.), or data characterizing liabilities of the commercial customer (e.g., types of liabilities, aggregate value of the liabilities, terms associated with these liabilities, etc.). As described herein, the accessed second portion of modelling data 220 may also include information that facilitates a prediction of financial metric values 218B based on the specified input data, e.g., information specifying a linear, non-linear, or geometric combination of the specified elements of input data and a corresponding normalization scheme.

Input processing module 206 may perform operations that parse the second portion of modelling data 220 to identify those elements of financial input data associated with financial predictive module 216B (e.g., the sales, asset, and/or liability data). In some instances, input processing module 206 may obtain at least a portion of the specified elements of financial input data from customer profile data 208 (e.g., and additionally, or alternatively, from portions of customer transaction data 210 or customer account data 212). Further, input processing module 206 may also derive additional portions of the financial input data, e.g., the temporal evolution in a commercial customer's sales, from portions of those elements of input data obtained from customer profile data 208, customer transaction data 210, or customer account data 212

Input processing module 206 may package the obtained or derived elements of financial input data and corresponding customer identifiers into portions of input data 214B, which input processing module 206 may provide as an input to financial predictive module 216B. In some examples, financial predictive module 216B may process portions of input data 214B in accordance with the second portion of modelling data 220, and may compute the financial index value associated with each of the customers specified within input data 214B (e.g., as associated with corresponding customer identifiers). Financial predictive module 216B may associate each of the financial index values with a corresponding one of the customer identifiers, and package the general index values and the associated customer identifiers within financial metric values 218B (e.g., which establishes an array of associated financial index values and customer identifiers).

In other examples, input processing module 206 may extract, from monitoring database 136, a third portion of modelling data 220 that specifies the one or more predictive models applied by behavioral predictive module 216C to predict behavioral metric values 218C, and that also specifies certain elements of input data associated with the one or more predictive models. By way of example, and without limitation, the third portion of modelling data 220 may specify that behavioral metric values 218B represent a financial index values computed based on elements of input data that, among other things, characterize an interaction between each of the customers and not only the financial institution, but also the payment, credit, or other financial instruments issued or serviced by that financial institution.

For instance, the elements of input data associated with behavioral predictive module 216C may include, but are not limited to: (i) data characterizing one or more occurrences of a overdrafts involving the financial instruments issued to the customers, e.g., a number of overdrafts within a specified period, a temporal interval between overdrafts, a value of one or more of the overdrafts, etc.; (ii) data characterizing balances, including negative balances, of one or more of the payment, credit, or financial instruments issued by the customers, e.g., actual balances, occurrences of negative balances, durations of negative and positive balances, a temporal interval between negative balances, etc.; and (iii) data characterizing fees paid by the customers due to overdrafts, negative balances, or other delinquency events, e.g., aggregate amounts of fees paid due to overdrafts, negative balances, or other delinquency events during one or more temporal intervals, a temporal evolutions in the fees paid, etc. Further, and as described herein, the accessed third portion of modelling data 220 may also include information that facilitates a prediction of behavioral metric values 218B based on the specified input data, e.g., information specifying a linear, non-linear, or geometric combination of the specified elements of input data and a corresponding normalization scheme for the behavioral index values.

Input processing module 206 may perform operations that parse the third portion of modelling data 220 to identify those elements of input data associated with behavioral predictive module 216C. In some instances, input processing module 206 may obtain at least a portion of the specified elements of the behavioral input data from customer profile data 208 (e.g., and additionally, or alternatively, from portions of customer transaction data 210 or customer account data 212). Further, input processing module 206 may also derive additional portions of the specified input data, e.g., the temporal evolution in a commercial customer's sales, from portions of those elements of input data obtained from customer profile data 208, customer transaction data 210, or customer account data 212.

As described herein, input processing module 206 may package the obtained or derived elements of behavioral input data and corresponding customer identifiers into portions of input data 214C, which input processing module 206 may provide as an input to behavioral predictive module 216C. In some examples, behavioral predictive module 216C may process portions of input data 214C in accordance with the third portion of modelling data 220, and may compute the financial index value associated with each of the customers specified within input data 214C (e.g., as associated with corresponding customer identifiers). Behavioral predictive module 216C may associate each of the financial index values with a corresponding one of the customer identifiers, and package the behavioral index values and the associated customer identifiers within behavioral metric values 218C (e.g., which establishes an array of associated behavioral index values and customer identifiers).

Referring back to FIG. 2, predictive modules 216 may provide component metric values 218, which include, but are not limited to, general metric values 218A, financial metric values 218B, and behavioral metric values 218C, as an input to an aggregation module 222 of predictive engine 138. In some instances, aggregation module 222 may perform any of the exemplary processes described herein to compute, for each of the identified customers, a composite metric value 224 based on combinations of corresponding ones of general metric values 218A, financial metric values 2186, and behavioral metric values 218C. Each of composite metric values 224 may, for example, reflect a risk to the financial institution that results from a provisioning of financial services to corresponding ones of the customers (e.g., the commercial customers described herein), and may represent a relative contribution of the generate, financial, and behavioral risk factors described herein.

In some examples, aggregation module 222 may generate, for each of the identified customers, a corresponding one of composite metric values 224 based on a linear combination of corresponding ones of general metric values 218A, financial metric values 218B, and behavioral metric values 218C (e.g., a simple or a weighted average, etc.) or based on a non-linear combination of corresponding ones of general metric values 218A, financial metric values 2186, and behavioral metric values 218C (e.g., a geometric average, a non-linear or polynomial function, etc.). In other examples, aggregation module 222 may generate a corresponding one of composite metric values 224 for each of the identified customers based on an application a regression model to corresponding ones of general metric values 218A, financial metric values 218B, or behavioral metric values 218C (e.g., a multivariable regression model, a multiple linear or non-linear regression model, a logistic repression model, etc.).

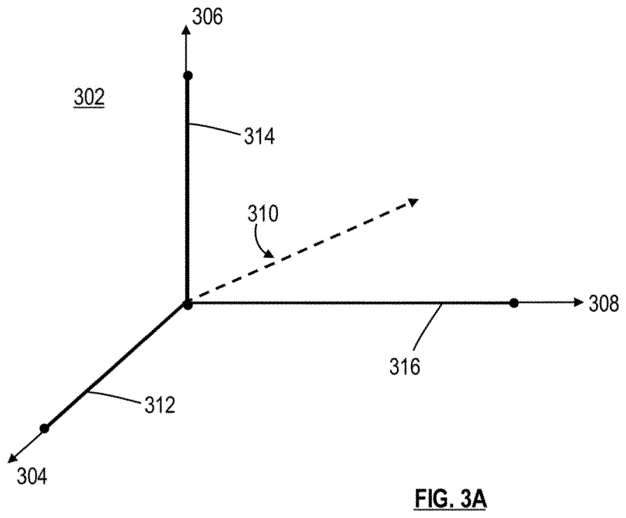

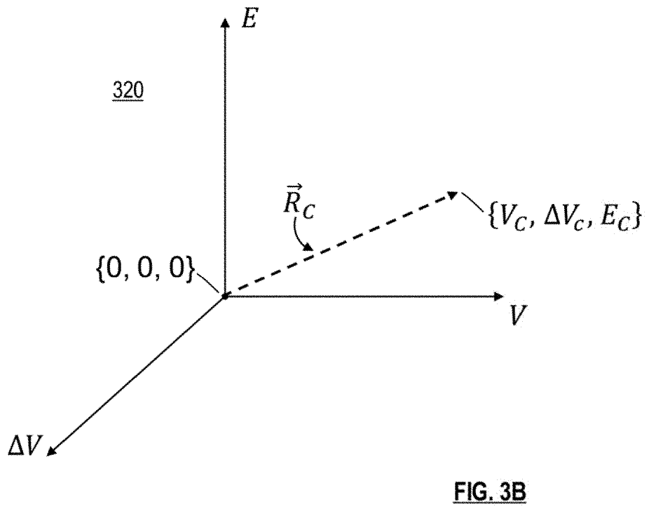

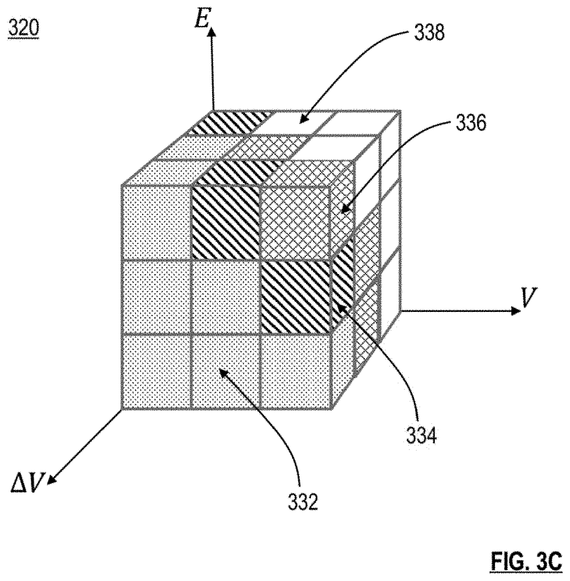

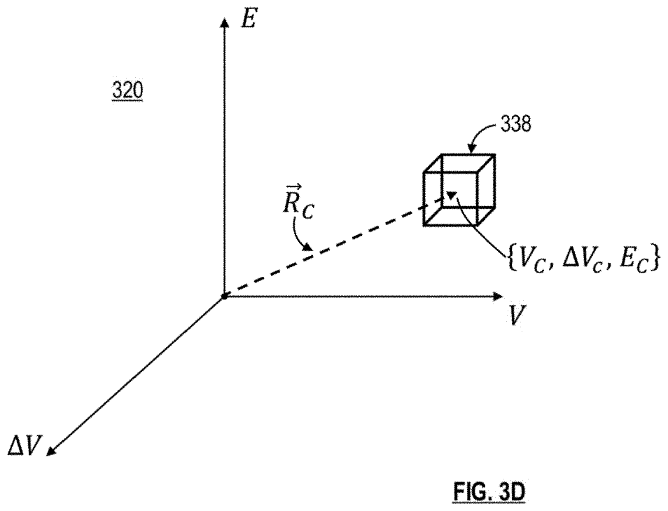

Additionally, in some examples, component metric values 218 may establish a multidimensional metric-value coordinate space, and one or more composite metric values 224 may be represented a vector within that multidimensional metric-value coordinate space having components defined by corresponding ones of component metric values 218. For instance, component metric values 218 may include general metric values 218A, financial metric values 2186, or behavioral metric values 218C ranging in magnitude from zero (e.g., no risk) to unity (e.g., highest risk), and as illustrated in FIG. 3A, a multidimensional metric-value coordinate space 302 may be defined by coordinate axes associated with respective ones of the general metric (e.g., coordinate axis 304 of FIG. 3A), the financial metric (e.g., coordinate axis 306 of FIG. 3A), and the behavior metric (coordinate axis 308 of FIG. 3A).

Further, and for each of the identified customers (e.g., the commercial customers described herein), corresponding ones of the general metric values 218A, financial metric values 2186, or behavioral metric values 218C can establish a triplet of component values that establishes a vector within the multidimensional metric-value coordinate space, e.g., multidimensional metric-value coordinate space 302 of FIG. 3A. In some instances, aggregation module 222 may compute the composite metric value for each of the customers (e.g., corresponding ones of composite metric values 224) based a determined magnitude of the corresponding vector within multidimensional metric-value coordinate space, such as, but not limited to, a Euclidean norm of the corresponding vector or a quadratic form of the corresponding vector.

As illustrated in FIG. 3A, and for a particular one of the commercial customers, the corresponding ones of general metric values 218A, financial metric values 2186, or behavioral metric values 218C can establish a Euclidean vector, e.g. vector 310, within multidimensional metric-value coordinate space 302. Further, also illustrated in FIG. 3A, scalar projection 312 of vector 310 onto coordinate axis 304 represents the corresponding one of general metric values 218A associated with the particular commercial customer, a scalar projection 314 of vector 310 onto coordinate axis 306 represents the corresponding one of financial metric values 218B associated with the particular commercial customer, and a scalar projection 316 of vector 310 onto coordinate axis 308 represents the corresponding one of behavioral metric values 218C associated with the particular commercial customer. Further, and as described herein, aggregation module 222 may establish a determine magnitude of vector 310 (e.g., as a Euclidean norm of scalar projections 312, 314, and 316) as a composite metric value for the particular commercial customer.

The disclosed embodiments are, however, not limited to these exemplary processes for computing composite metric values for the identified customers based on corresponding elements of general metric values 218A, financial metric values 218B, or behavioral metric values 218C. In other instances, aggregation module 222 can perform any additional, or alternate, operations that combine or aggregate the elements of general metric values 218A, financial metric values 218B, or behavioral metric values 218C, or any other appropriate one of component metric values 218, into corresponding elements of composite metric values 224 for the commercial customers of the financial institution, for one or more individual customers of the financial institution, or for any combination thereof.

Referring back to FIG. 2, aggregation module 222 may associate the determined composite metric values for each of the identified customers with a corresponding one of the customer identifiers, and may package the composite metric values and the associated customer identifiers within corresponding elements of composite metric values 224. In some instances, aggregation module 222 may provide all or a portion of composite metric values 224 (e.g., that specify the component metric values for each of the identified customers of the financial institution, such as the commercial customers described herein) as an input to a risk parameterization module 226 of predictive engine 138. In some instances, risk parameterization module 226 may perform operations that parameterize a multidimensional risk profile, and generate a corresponding element of risk profile data 228, for each of the identified customers based on corresponding ones of composite metric values 224, a time evolution of the corresponding one of composite metric value 224 across one or more prior temporal intervals, and additional data characterizes an interaction between the identified customers and the financial institution.

By way of example, risk parameterization module 226 may extract a composite metric value for each of the identified customers (e.g., the commercial customer described herein) from composite metric values 224. Risk parameterization module 226 may also access the data records of monitoring database 136 and extract metric value data 230 that specifies, for one or more of the identified customers, the composite metric values determined during at least one prior temporal interval. Further, and as illustrated in FIG. 2, risk parameterization module 226 may access one or more of customer profile data 208, customer transaction data 210, or customer account data 212 and extract all or a portion of the additional data characterizes an interaction between the identified customers and the financial institution. For instance, risk parameterization module 226 may access customer transaction data 210 and extract exposure data 232 characterizing an amount of credit associated with one or more payment instruments (e.g., a credit card), credit instruments (e.g., a revolving line of credit or a commercial loan), or other financial instruments issued by the financial institution to each of the identified customers, e.g., the commercial customers described herein.

Based on metric value data 230, risk parameterization module 226 may perform operations that compute a temporal evolution 234 in the composite metric score (e.g., as specified within composite metric values 224) for each of the identified customers. In some instances, however, metric value data 230 may fail to specify a previously determined composite metric value for one or more of the identified customers (e.g., a current monitoring cycle may represent a first application of the exemplary, exception-based monitoring processes to these one or more identified customers), and based on the lack of the previously determined metric value, risk parameterization module 226 may assign predetermined value to temporal evolution 234 for these one or more identified customers, such as a value or zero, a value or unity, or an alphanumeric flag. Further, and based on exposure data 232, risk parameterization module 226 may compute, for each of the identified customers, a value 236 indicative of a total exposure of the financial institution (e.g., a total amount of extended credit) that results from the issued payment, credit, or other financial instruments.

Referring back to FIG. 2, risk parameterization module 226 may generate an element of risk profile data 228 for each of the identified customers that includes, but is not limited to a corresponding one of the customer identifiers, a corresponding one of composite metric values 224, a corresponding one of computed temporal evolutions 234, and a corresponding one of the total exposure values 236. In some instances, by establishing the multidimensional risk profile for a particular customer based on the composite metric value and the temporal evolution of that composite metric value, certain of the exemplary, exception-based monitoring processes can characterize the risk to the financial institution derived from not only the general, financial, or behavioral characteristics of the particular customer, but also on a detected volatility in these characteristics (e.g., a customer characterized by a small, but highly volatile, composite metric value may represent more substantial risk to the financial institution than an additional customer characterized by a larger, but stable, composite metric value).

Further, by establishing the multidimensional risk profile for the particular customer based on the total exposure of the financial institution to payment, credit, or other financial instruments issued to that particular customer, certain of the exemplary, exception-based monitoring processes described herein can further characterize the risk to the risk to the financial institution derived from that exposure, even when that exposure results from otherwise stable, risk-averse customers. For example, a customer characterized by relatively small and stable composite metric value, but a significant credit exposure, may represent a more significant risk to the financial institution than an additional customer characterized by a larger or more volatile composite metric value, but a minimal credit exposure.

Referring back to FIG. 2, risk parameterization module 226 may provide the elements of risk profile data 228, which establish and parameterize the multidimensional risk profile for each of the customers, to a risk segmentation module 238 of predictive engine 138. In some instances, and as described herein, risk segmentation module 238 may access each element of risk profile data 228, which specifies a composite metric value (e.g., a corresponding one of composite metric values 224), a temporal evolution in that composite metric value (e.g., a corresponding one of temporal evolutions 234), and a value of a total exposure (e.g., a corresponding one of total exposure values 236) for a corresponding one of the identified customers of the financial institution. Based on corresponding ones of the composite metric values, the temporal evolutions, and the total exposure values (e.g., within the accessed elements of risk profile data 228), risk segmentation module 238 may perform any of the exemplary processes described herein segment the identified customers of the financial institution into corresponding levels of potential risk, e.g., low risk, slight risk, strong risk, or high risk.

As illustrated in FIG. 2, risk segmentation module 238 may access the data records of monitoring database 136 and extract segmentation data 240, which identifies and characterizes each of the levels of potential risk to the financial institution, and further, which facilitates a segmentation of each of the customers into a corresponding one of the levels of potential risk. In some instances, segmentation data 240 may define each of the levels of potential risk (e.g., low risk, slight risk, strong risk, or high risk) based on a corresponding value, or range of values, of the composite metric value, the temporal evolution in the composite metric value, and additionally, or alternatively, the total exposure value.

In some examples, segmentation data 240 may define a first threshold value associated with the composite metric value, a second threshold value associated with the temporal evolution in the composite metric value, and a third threshold value associated with the total exposure value. Further, segmentation data 240 may segment each of the identified customers into a corresponding one of the levels of potential risk based on a determined satisfaction of a first threshold criterion (e.g., that the composite metric value exceeds the first threshold value), a second threshold criterion (e.g., that the rate of change of the composite metric value exceeds the second threshold value), or a third threshold criterion (e.g., that the total exposure value exceeds a third threshold value).

For instance, segmentation data 240 may specify that a particular one of the identified customers represents a “low risk” to the financial institution when a corresponding element of risk profile data 228 satisfies neither the first, second, nor third threshold criteria. In other instances, segmentation data 240 may specify that the particular one of the identified customers represents a “slight risk” to the financial institution when the corresponding element of risk profile data 228 satisfies a single one of the first, second, or third threshold criteria, and additionally, or alternative, that the particular one of the identified customers represents a “strong risk” to the financial institution when the corresponding element of risk profile data 228 satisfies any two of the first, second, or third threshold criteria. Further, segmentation data 240 may also specify that the particular one of the identified customers represents a “high risk” to the financial institution when the corresponding element of risk profile data 228 satisfies each of the first, second, or third threshold criteria.

In other examples, segmentation data 240 may also define ranges of the composite metric value, the rate of change of that composite metric value, and the total exposure value that would characterize the provision of the financial services to a particular customer as a low risk, a slight risk, strong risk, or a high risk to the financial institution. By way of example, segmentation data 240 may define a low-risk range for each of the composite metric value, the rate of change in that composite metric value, and the total exposure value, and may further specify that a particular one of the identified customers represents a “low risk” to the financial institution when its corresponding composite metric value, rate of change, and total exposure value are each disposed within corresponding ones of the low-risk ranges of values. Segmentation data 240 may also define a high-risk range for each of the composite metric value, the rate of change in that composite metric value, and the total exposure value, and may specify that a particular one of the identified customers represents a “high risk” to the financial institution when one, or more, of its composite metric value, rate of change, and total exposure value are disposed within a corresponding one of the high-risk ranges of values.

Further, segmentation data 240 may also define one or more ranges, or combinations of ranges, of the composite metric value, the rate of change of that composite metric value, and the total exposure value that would characterize the provision of the financial services to a particular customer as a slight risk or strong risk to the financial institution. For instance, segmentation data 240 may specify that a particular one of the identified customers represents a slight risk to the financial institution when its composite metric value, rate of change, and total exposure value are each disposed within a corresponding one of the slight-risk ranges of values and additionally, or alternatively, when its composite metric value, rate of change, and total exposure value are each disposed within a specified combination of the corresponding ones of the low- and slight-risk ranges. For example, segmentation data 240 may establish that the provision of the financial services to the particular customer may be considered a slight risk to the financial institution when the particular customer's composite metric value is disposed within a low-risk range, and when the rate of change in the particular customer's composite metric score and the particular customer's total exposure value are each disposed within a slight-risk range.

Segmentation data 240 may also specify that a particular one of the identified customers represents a “strong risk” to the financial institution when its composite metric value, rate of change, and total exposure value are each disposed within a corresponding one of the strong-risk ranges of values and additionally, or alternatively, when its composite metric value, rate of change, and total exposure value are each disposed within a combination of the corresponding strong-risk ranges, slight risk ranges, and in some instances, low-risk range. For example, segmentation data 240 may establish that the provision of financial services to a particular customer may be considered a strong risk to the financial institution when the particular customer's composite metric value and total exposure value are each disposed within a strong risk range, and when the rate of change in the particular customer's composite metric value is disposed within either of a low- or slight-risk range.

In other instances, and as illustrated in FIG. 3B, each element of risk profile data 228 may also be represented as a Euclidean vector (e.g., a “risk” vector) for the corresponding customer within a multidimensional coordinate space, e.g., a “risk” space 320 parameterized by the composite metric values V, the temporal rates of change ΔV in the composite metric values, and the total exposure values E. For example, in FIG. 3B, an initial point of a risk vector (e.g., \vec{R}_{C}) for a particular one of the identified customers (e.g., customer C) may be disposed at an origin of risk space, e.g., point {0, 0, 0} in risk space 320. Further, in FIG. 3B, a terminal point of the risk vector \vec{R}_{C} may be disposed at a point within the risk space defined by the particular customer's composite metric value V_{C}, the temporal rate change ΔV_{c} in the particular customer's composite metric value, and total exposure value E_{C} (e.g., point {V_{C}, ΔV_{c}, E_{C}} in risk space 320 FIG. 3B).

In some examples, segmentation data 240 may decompose or segment the risk space into discrete, bounded regions that include corresponding points within the risk space (e.g., as defined by corresponding composite metric values, temporal rates of change, and total exposure values), and assign a level of potential risk to each of the bounded subspaces. For instance, as illustrated in FIG. 3C, segmentation data 240 may decompose risk space 320 into subspaces that include, but are not limited to: (i) a first subspace 332 associated with composite metric values, temporal rates of change, and total exposure values that represent a low risk to the financial institution, e.g., indicated by the dotted regions of risk space 320; (ii) a second subspace 334 associated with composite metric values, temporal rates of change, and total exposure values that represent a slight risk to the financial institution, e.g., indicated by the diagonally hashed regions of risk space 320; (iii) a third subspace 336 associated with composite metric values, temporal rates of change, and total exposure values that represent a strong risk to the financial institution, e.g., indicated by the crossed-hash regions of risk space 320; and (iv) a fourth subspace 338 associated with composite metric values, temporal rates of change, and total exposure values that represent a high risk to the financial institution, e.g., the regions of risk space 320 without dots or hashing.

In some instances, risk segmentation module 238 may, for a particular one of the identified customers, access a corresponding element of risk profile data 228, and extract the composite metric value, the temporal rate change in that composite metric value, and the total exposure value for that particular customer. As illustrated in FIG. 3D, the composite metric value (e.g., V_{C}), the temporal rate of change in that composite metric value (e.g., ΔV_{c}), and the total exposure value (e.g., E_{C}) may establish a risk vector \vec{R}_{C} for the particular customer within risk space 320. Further, and as illustrated in FIG. 3D, segmentation module 340 may perform any of the exemplary processes described herein to establish that a terminal point of that corresponding risk vector \vec{R}_{C}, e.g., point {V_{C}, ΔV_{c}, E_{C}}, is disposed within fourth subspace 338 of risk space 320, which indicates that the provision of the financial services to the particular customer represents a high risk to the financial institution.

As described herein, segmentation data 240 may, when processed by risk segmentation module 238, facilitate a segmentation of the identified customers into corresponding levels of risk to the financial institution based on the parameter-specific threshold values, the risk-level-specific ranges of parameter values and additionally, or alternatively, the segmentation of the risk subspace into corresponding ones of the risk-level-specific subspaces. In some instances, one or more of these parameter-specific threshold values, risk-level-specific ranges of parameter values or risk-level-specific subspaces may be established, or empirically determined by the financial institution associated with monitoring system 130, e.g., based on predetermined risk-management protocols or based on requirements set forth by a governmental or regulatory entity. In other instances, monitoring system 130 may perform operations that adaptively determine one or more parameter-specific threshold values, risk-level-specific ranges of parameter values or risk-level-specific subspaces based on an application of any of the machine learning processes or artificial intelligence models described herein to training data, e.g., the composite metric values, temporal rates of change in the composite metric values, and total exposure values, associated with known or observed levels of risk to the financial institution, e.g., low, slight, strong, or high risk.

Referring back to FIG. 2, and risk segmentation module 238 may access the one or more elements of risk profile data 228 for each identified customer of the financial institution (e.g., as received as an input from risk parameterization module 226) and may obtain segmentation data 240 from the data records of monitoring database 136. Based on the elements of risk profile data 228 and corresponding portions of segmentation data 240, risk segmentation module 238 may perform any of the exemplary processes described herein to assign a corresponding one of the levels of potential risk to the financial institution, e.g., low risk, slight risk, strong risk, or high risk, to each of the identified customers of the financial institution.

In some instances, risk segmentation module 238 may generate risk level data 242 that includes, for each of the identified customers of the financial institution, the corresponding customer identifier and the assigned risk level associated with the provision of financial services to that customer by the financial institution, e.g., the low, slight, strong, or high risks described herein. Risk segmentation module 238 may also perform operations that store generated risk level data 242 within a locally accessible data repository, such as, but limited to, monitoring database 136, along with temporal data characterizing a time or date at which risk segmentation module 238 assigned the levels of potential risk to the identified customers. Further, risk segmentation module 238 may provide risk profile data 228 and risk level data 242 as inputs to an exception module 244 of monitoring system 130, which may perform any of the exemplary processes described herein to identify, and trigger an initiation of, one or more operations consistent with the level of potential risk assigned to each of the identified customers of the financial institution (e.g., as specified within risk level data 242) and additionally, or alternatively, with the parameterized risk profile of each of these identified customers (e.g., as specified within risk profile data 228).

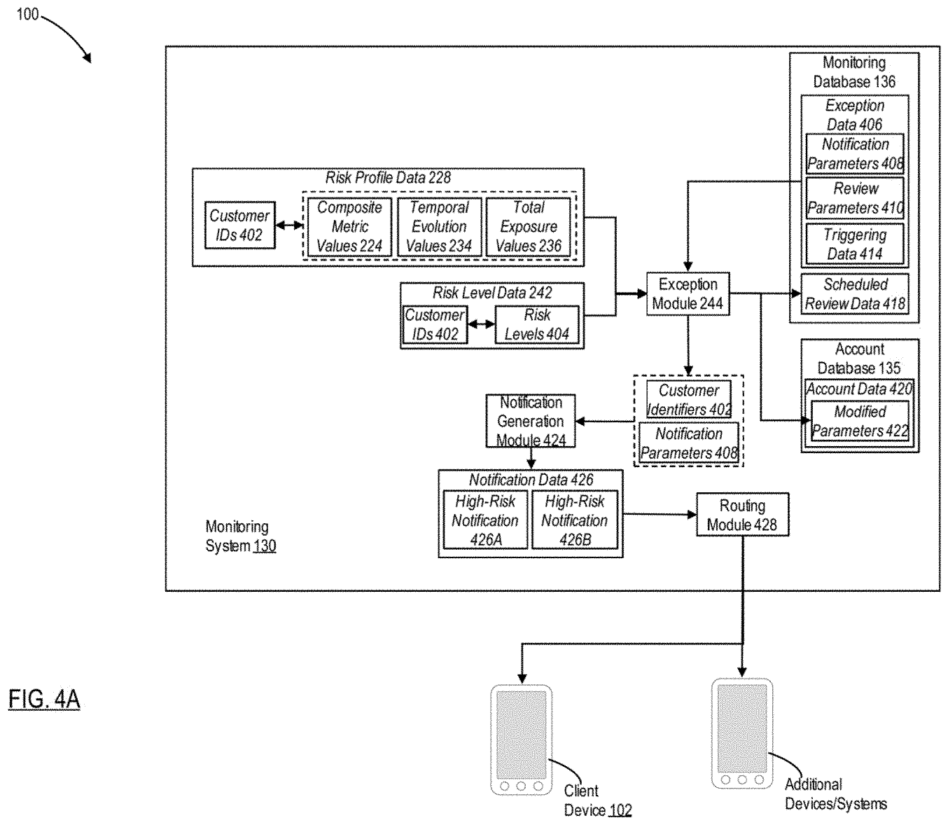

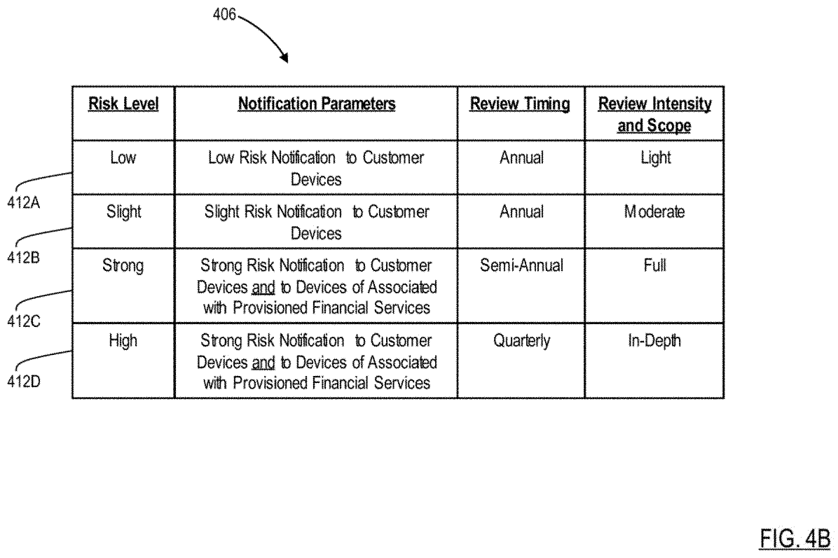

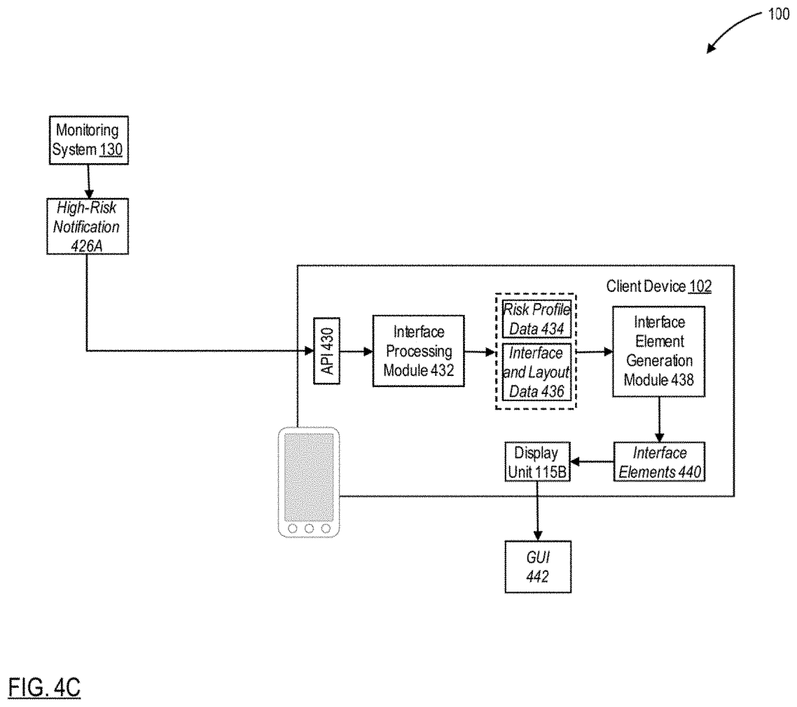

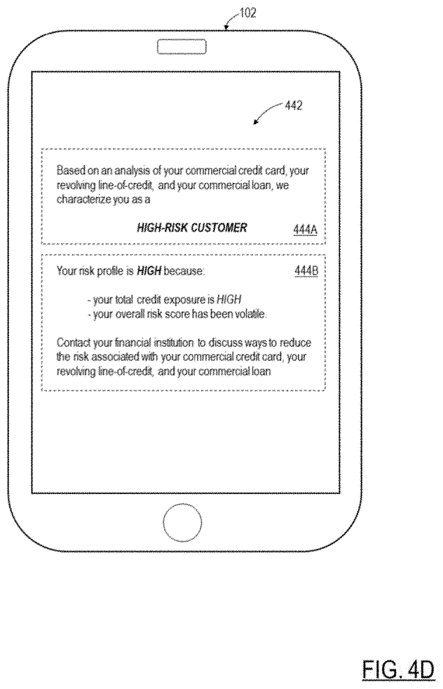

Referring to FIG. 4A, exception module 244 may receive risk profile data 228, which parameterizes the risk profile for each of the identified customers of the financial institution, and risk level data 242, which identifies a level of potential risk to the financial institution resulting from the provisioning of financial services to each of the identified customers As described herein, risk profile data 228 may include, for each of the identified customer, a corresponding customer identifier 402 (e.g., an alphanumeric identifier, etc.), a composite metric value (e.g., a corresponding one of composite metric values 224), a temporal rate of change in that composite metric value (e.g., a corresponding one of temporal evolutions 234), and a total exposure value (e.g., a corresponding one of the total exposure values 236). Further, and as described herein, risk level data 242 may include, for each of the identified customers, corresponding customer identifier 402 and an assigned level of potential risk 404, e.g., any of the low, slight, strong, and high levels of potential risk described herein.

Upon receipt of risk profile data 228 and risk level data 242, exception module 244 may perform operations that access the data records of monitoring database 136, and that extract exception data 406 that, among other things, identifies and characterizes operations consistent with each of the levels of customer risk, e.g., the low, slight, strong, and high levels of potential risk described herein. In some example, exception data 406 may also identify and characterize one or more triggering criterion that, when satisfied by portions of risk profile data 228 and risk level data 242, triggers a performance of one or more of the operations by monitoring system 130.

In one instance, exception data 406 may include notification parameters 408 that identify and characterize one or more notification operations capable of performance by monitoring system 130 upon detection of a particular level of customer risk, e.g., as specified within risk level data 242. Examples of these notification operation include, but are not limited to, a generation and transmission of a customer-specific notification to network-connected devices or systems operated by the customers of the financial institution, employees or agents of the financial institution, and additionally, or alternatively, other business, governmental, or regulatory entities associated with the provisioned financial services (e.g., an underwriter of a commercial loan, a commercial lender, a governmental agency, etc.).

Further, in some instances, monitoring system 130 may also perform operations that facilitate a review of the financial services provisioned to one or more customers, and the underlying risk factors associated with the provisioned financial services, in accordance with a predetermined or a periodic schedule, such as on a quarterly basis, a semi-annual basis, or a yearly basis. The performance of these operations may, for example, generate data indicative of a potential risk resulting from the provisioning of the financial services to certain customers, and enable the financial institution to identify those customers “at risk” of a defaulting on certain provisioned payment, credit, or other financial services. In some examples, exception data 406 may also include review parameters 410 that establish a review schedule for customers segmented into each of the levels of potential customer risk, and further specifies, for each of the levels of customer risk, an intensity and a scope of the scheduled review.

Referring to FIG. 4B, exception data 406 may include a plurality of structured data records that maintain elements of notification parameters 408 and review parameters 410 associated with each of the levels of potential customer risk described herein. By way of example, and for a low-risk customer (e.g., a customer associated with a low composite metric value, a minimal volatility in that composite metric value, and minimal total exposure value), data element 412A may specify notification operations that include, but are not limited to, generating and transmitting a low-risk notification to a network-connected device or system operated by the customer, and further, may specify a light-intensity, yearly review that establishes whether any future general, financial, and behavioral risk factors indicate an increased risk to the financial institution.

Further, and for a customer characterized as a slight risk to the financial institution (e.g., a customer associated with increased composite metric values, volatility, and total exposure), data element 412B may specify notification operations that include, but are not limited to, generating and transmitting a slight-risk notification to a network-connected device or system operated by the customer, and may specify a yearly review of moderate intensity. By way of example, the moderate-intensity review may confirm both the current status of the general, financial, and behavioral risk factors for the customer and that any expected changes in these general, financial, and behavioral risk factors would reduce, or not increase, the potential risk to the financial institution.

For a customer characterized as a strong risk to the financial institution (e.g., a customer associated with a moderate composite metric value, a moderate volatility, and/or a high-value exposure), or as a high risk to the financial institution (e.g., a customer associated with a highest composite metric value, volatility, and/or exposure), data elements 412C and 412D may each specify notification operations that include, but are not limited to, generating and transmitting a strong-risk notification to a network-connected device or system operated by the customer and further, to an additional network-connected device or system operated by business, governmental, or regulatory entities associated with the provisioned financial services, e.g., an underwriter or servicer of a commercial loan, etc.

For the strong-risk customer, data element 412C may specify a full review on a semi-annual basis, which identifies each of the payment, credit, or other financial instruments provisioned to the customer, and which characterizes a current and future impact of the underlying general, financial, and behavioral risk factors on the potential risk to the financial institution. Further, for the high-risk customer, data element 412D may specify an in-depth, quarterly review that not only identifies each of the payment, credit, or other financial instruments provisioned to the customer and characterizes a current and future impact of the underlying general, financial, and behavioral risk factors on the potential risk to the financial institution, but also reassesses the acceptance of the potential risk resulting from the provisioning of the financial services to the high-risk customer, e.g., through a modification to the terms of the provisioned payment, credit, or financial instruments.

The disclosed embodiments are, however, not limited to these exemplary levels of potential risk, or to these examples of notification and review parameters. In other instances, the data records of exception data 406 may identify and characterize notification operations or review parameters consistent with any additional, or alternate, level of potential risk to the financial institution that would be appropriate to the provisioned financial services or to the customers. Further, in additional instances, the data records of exception data 406 may also identify and characterize any additional, or alternate, notification or review parameters (include a lack of a notification or a lack of review), and any additional, or alternate operations (including a modification of the terms of a provided payment or credit instrument) that would be appropriate to the levels of potential risk.

Referring back to FIG. 4A, exception data 406 may also include triggering data 414 associated with the elements of the elements of risk profile data 228 (e.g., composite metric values 224, temporal evolutions 234 in the composite metric values, and total exposure values 236 for each of the identified customers of the financial institution) and additionally, or alternatively, the elements of risk level data 242. For instance, triggering data 414 may identify and characterize one or more operations capable of performance by monitoring system 130, and may link the performance of each of the operations to a detection, by exception module 244, of a customer-specific triggering condition.

Examples of these customer-specific triggering conditions may include, but are not limited to, a composite metric value, a temporal rate of change in the composite metric value, or a total exposure value of a particular customer that exceeds a corresponding threshold value, an assignment of a risk level to a particular customer, or an increase in the risk level assigned to the customer (e.g., an increase in risk level from slight to high, etc.). Further, examples of the triggered operations include, but are not limited to, a modification to a term associated with a provisioned payment instrument (e.g., a commercial credit card, etc.) or a provisioned credit instrument (e.g., a revolving line of credit, a commercial loan, etc.), an acceleration of a scheduled review, or an initiation of out-of-band communications by an employee of the financial institution, e.g., a telephone call, etc.

For instance, triggering data 414 may establish a customer-specified triggering condition that includes, but is not limited to, a threshold amount of credit exposure for each of the commercial customers of the financial institution. Triggering data 414 may also specify that, upon a determination that the total exposure value for a particular one of the commercial customers exceeds the threshold amount, monitoring system 130 performs operations that include, but are not limited to, modifying the terms of one or more provisioned payment instruments or credit instruments to reduce the total exposure value below the threshold amount (e.g., by reducing an amount of credit available to the particular commercial customer through a revolving line of credit, or by increasing a variable interest rate associated with a commercial loan), and generating and transmitting an exception notification that identifies the triggering condition and the resulting modification to a network-connected device or system associated with the particular commercial customer, e.g., client device 102 of FIG. 1.

In other instances, triggering data 414 may establish a customer-specific triggering condition based on a detected change in a level of potential risk across multiple temporal intervals. For example, triggering data 414 may specify that, in response to a detected change in a customer's risk level from low or slight risk to high risk, monitoring system 130 performs operations that initiate an immediate, in-depth review of the payment, credit, or other financial instruments provisioned to a corresponding customer, and that suspend the provisioning of any further financial services to that corresponding customer until completion of the in-depth review, e.g., to minimize future exposure to risk. The disclosed embodiments are, however, not limited to these exemplary triggering conditions and triggered operations, and in other instances, triggering data 414 may include any additional or alternate triggering conditions and triggered operations that would be appropriate to the elements of risk profile data 228 and risk level data 242, to the provisioned financial services, and to the individual or commercial customers of the financial institution.

Referring back to FIG. 4A, exception module 244 may perform operations that parse risk profile data 228 to extract a corresponding one of customer identifiers 402, composite metric values 224, temporal evolutions 234 in the composite metric values, and total exposure values 236 for each of the identified customers of the financial institution. Further, exception module 244 may also perform operations that parse risk level data 242, and extract a corresponding of the levels of potential risk (e.g., the low, slight, strong, and high levels of potential risk described herein) assigned to each of the customers and associated with each of customer identifiers 402.

Based on the data records of exception data 406, exception module 244 may identify portions of review parameters 410 that are consistent with the levels of potential risk assigned to each of the identified customers of the financial institution. As described herein, review parameters 410 may specify, among other things, a timing of a scheduled review (e.g., yearly, semi-annually, quarterly, etc.) and an intensity and a scope of the scheduled review (e.g., the light, moderate, full, or in-depth) that would be consistent with the level of potential risk assigned to each of the identified customers. As illustrated in FIG. 4A, exception module 244 may perform operations that associate each of customer identifiers 402 with information that identifies the corresponding timing, intensity, or scope of the scheduled review, and that package customer identifiers 402 and the associated information into corresponding portions of scheduled review data 418, which exception module 244 may store within the data records of monitoring database 136.

For example, for a particular one of the identified customers of the financial institution (e.g., the commercial customer described herein), risk level data 242 may indicate that the payment, credit, or other financial instruments provisioned to that particular customer represent a high risk to the financial institution. Based on the data records of exception data 406, exception module 244 may establish that the scheduled review for the particular commercial customer should correspond to an in-depth review conducted on a quarterly basis. As described herein, exception module 244 may package a customer identifier of the particular commercial customer (e.g., a corresponding one of customer identifiers 402) and information characterizing the in-depth, quarterly review for the particular customer into an element of scheduled review data 418, e.g., for storage within monitoring database 136.

Further, exception module 244 may also obtain triggering data 414 from exception data 406, and parse triggering data 414 to identify one of the customer-specific triggering conditions and triggered operations. Exception module 244 may perform additional operations that determine whether any of the customer-specific triggering conditions are consistent with a composite metric value (e.g., as specified within composite metric values 224), a temporal rate of change in the composite metric value (e.g., as specified within temporal evolutions 234), and a total exposure value (e.g., as specified within total exposure values 236) for one or more of the identified customers, and additionally or alternatively, with a risk level that characterizes one or more of the identified customers (e.g., as specified within risk level data 242). In some instances, and in response to a determined consistency, exception module 244 may initiate corresponding ones of the triggering operations for one or more of the identified customers.

By way of example, exception module 244 may determine that the total risk exposure for the high-risk commercial customer described herein exceeds a threshold amount of exposure (e.g., a specified triggering condition) specified within triggering data 414 and in response to the determination, exception module 244 may perform operations that modify one or more terms of a provisioned payment or credit instrument to reduce the total exposure value of the high-risk commercial customer (e.g., an initiation of a corresponding triggered operation). In some instances, exception module 244 may obtain a customer identifier associated with the high-risk commercial customer (e.g., a corresponding one of customer identifiers 402), and based on the customer identifier, may access data 420 within account database 135 that identifies and characterizes one or more payment or credit instrument provisioned to the high-risk commercial customer.

For instance, the financial institution may provision a revolving line of credit to the high-risk commercial customer and may service a commercial loan associated with the high-risk commercial customer, and data 420 may specify values of one or more parameters that characterize the revolving line of credit and the commercial loan, e.g., amount of credit available to via the revolving line of credit, and interest rates associated with the revolving line-of-credit and the commercial loan. In some examples, exception module 244 may access data 420, and generate modified parameter values 422 that, among other things, reduce the amount of credit available via the revolving line-of-credit and/or increase the interest rate of the revolving line-of-credit or the commercial loan. As described herein, the initiation and performance of these exemplary triggered operations by exception module 244 may dynamically reduce an exposure of the financial institution to the high-risk commercial customer automatically and without intervention from employees of the financial institution or from the high-risk commercial customer.

Referring back to FIG. 4A, and based on the data records of exception data 406, exception module 244 may also identify portions of notification parameters 408 that are consistent with the levels of potential risk assigned to each of the identified customers of the financial institution. As described herein, notification parameters 408 may specify that monitoring system 130 generate and transmit an appropriate risk notification to a network-connected device or system associated with each of the identified customers and in some instances, with a business, governmental, or regulatory entity associated with one or more of the financial services provisioned to one or more of the identified customers. Exception module 244 may perform operations that associate each of the identified portions of notification parameters 408 with a corresponding one of customer identifiers 402, and that provide the identified portions of notification parameters 408 and the associated customer identifiers as an input to a notification generation module 424 of monitoring system 130. Additionally, or alternatively, exception module 244 may also provide all or a portion of risk profile data 228 and risk level data 242 as inputs to notification generation module 424.

In some examples, notification generation module 424 may perform any of the exemplary processes described herein to generate the appropriate risk notification for each of the identified customers in accordance with corresponding portions of notification parameters 408 and additionally, or alternatively, with corresponding portions of risk profile data 228 or risk level data 242. Notification generation module 424 may receive notification parameters 408 (e.g., and additionally, or alternatively, risk profile data 228 or risk level data 242), and may generate notification data 426 for transmission to a network-connected device or system associated with each of the identified customers of the financial institution, e.g., as specified by corresponding ones of customer identifiers 402, and in some instances, to an additional network-connected device or system operated by a business, governmental, or regulatory entity associated with the financial services provisioned to one or more of the identified customers.

Notification data 426 may include, for each of the identified customers, data characterizing a corresponding one of the assigned levels of potential risk, e.g., the low-, slight-, strong-, or high-risk levels obtained from corresponding portions of risk level data 242. In further instances, generated notification data 426 may also include information characterizing the parameterized risk profile of each of the identified customers, including, but not limited to, corresponding ones of composite metric values 224, temporal evolutions 234 in the composite metric values, and total exposure values 236, e.g., as extracted from risk profile data 228.

Additionally, or alternatively, notification data 426 may also include, for one or more of the identified customers, data characterizing a change in the assigned level of potential risk, or in the parameterized risk profile (e.g., composite metric values 224, temporal evolutions 234 in the composite metric values, and/or total exposure values 236), across prior temporal intervals. For instance, and for a particular one of the identified customers, a corresponding portion of notification data 426 may include a current level of potential risk assigned to the particular customers, along with historical risk data identifying the levels of potential risk assigned to the particular customer during prior temporal intervals, e.g., each month during a prior year.

In some examples, notification data 426 may also include interface or layout data that, when processed by a corresponding one of the network-connected devices or systems, facilitates a presentation of a corresponding notification within a digital interface and improves an ability or an ease of a user, such as user 101 or 121, to interact with or access that digital interface. For instance, the interface or layout data may assign, to each of the assigned levels of potential risk, a corresponding symbol or glyph that, when rendered for presentation within the digital interfaces by the network-connected devices or systems, enables a corresponding user to ascertain the assigned level or risk, or a change in the assigned level of risk, for a corresponding customer of the financial institution.

Further, and by way of example, the interface or layout data may associate a particular color with each of the assigned levels of potential risk, e.g., an association of green to low-risk customer, yellow to a slight-risk customer, orange to a strong-risk customer, or red to a high-risk customer. In some instances, when processed by a corresponding one of the network-connected devices or systems, the interface or layout data may cause the network-connected device or system to present, within a digital interface, information identifying a level of potential risk assigned to a corresponding customer, or a current or historical parameterization of the risk profile of that customer, in a color that is consistent with the assigned level of risk. By presenting a colored representation of the assigned level of potential risk, or of the current or historical parameterization of the risk profile, the exemplary embodiments described herein may enable a corresponding user, such as user 101 or 121, to perceive visually the assigned level of potential risk and to effectively interact with the presented digital interface, especially using network-connected devices having limited display functionality.

Referring back to FIG. 4A, notification generation module 424 may provide notification data 426, which includes discrete elements of notification data associated with corresponding customer identifiers or with identifiers of corresponding business, governmental, or regulatory entities, to a routing module 428 of monitoring system 130. In some instances, routing module 428 may perform operations that parse notification data 426 to identify each of the customer identifiers (and additionally, or alternatively, information identifying the business, governmental, or regulatory entities) associated with corresponding and discrete portions of notification data 416.

Routing module 428 may access customer database 132, and may identify and extract data identifying a network-connected device or system (e.g., a unique network address, such as an IP address, etc.) associated with each of the customer identifiers (and further, with the information identifying the business, governmental, or regulatory entities described herein). In some instances, routing module 428 may perform operations that cause monitoring system 130 to transmit corresponding portions of notification data 426 to the unique network addresses of the network-connected devices or systems, e.g., to client devices 102 or 122, which may perform operations that render the corresponding portions of notification data 426 for presentation within a digital interface in accordance with the interface or layout data.

By way of example, and for the high-risk commercial customer described herein, notification generation module 424 may perform any of the exemplary processes described herein to generate first high-risk notification 426A for transmission to a network-connected device or system associated with the commercial customer, such as client device 102 of FIG. 1. Further, and in accordance with portions of notification parameters 408, notification generation module 424 may also generate second high-risk notification 426B for transmission to one or more additional network-connected devices or systems operated by financial institutions or other business entities associated with the financial services provisioned to the commercial customer, e.g., the commercial credit card, the revolving line-of-credit, or the commercial loan. Notification generation module 424 may provide high-risk notifications 426A and 426B as inputs to routing module 428, which may perform any of the exemplary processes described herein to transmit first high-risk notification 426A to client device 102 and to transmit second high-risk notification 426B to the each of the one or more additional network-connected devices or systems (not illustrated in FIG. 4A).

In some examples, the network-connected devices or systems associated with the identified customers (and additionally, or alternatively, the network-connected devices or systems operated by financial institutions or other business entities associated with certain of the provisioned financial services) may receive corresponding portions of notification data 426, e.g., via corresponding secure programmatic interfaces. These network-connected devices or systems may each perform any of the exemplary processes described herein to render the corresponding portion of notification data 426 for presentation within a digital interface and in accordance with the interface or layout data.

For example, in reference to FIG. 4C, a secure programmatic interface of client device 102, e.g., application programming interface (API) 430, may receive high-risk notification 426A. As described herein, high-risk notification 426A may include, among other things, data identifying the high-risk commercial customer (e.g., a corresponding one of customer identifiers 402), data that characterizes risk profile of the high-risk customer (e.g., an indicator of the assigned high risk, corresponding elements of risk profile data 228, etc.), and corresponding elements of the interface or layout data described herein. In other instances, high-risk notification 426A may also include information that characterizes a time evolution of the risk profile of the high-risk customer, and additionally, or alternatively, that parameterizes the risk profile within a multidimensional risk space, such as risk space 320 of FIGS. 3B-3D.

API 430 may route high-risk notification 426A to an interface processing module 432 of executed banking application 108. In some instances, API 430 may be associated with or established by interface processing module 432, and may facilitate secure, module-to-module communications across network 120 between interface processing module 432 and routing module 428 of monitoring system 130.

In some examples, interface processing module 432 may parse high-risk notification 426A to extract data 434 characterizing the risk profile of the high-risk commercial customer (e.g., the assigned risk level, the composite metric value, the temporal evolution of that metric value, or the total exposure value), along with all or a portion of the interface and layout data described herein, e.g., interface and layout data 436. As illustrated in FIG. 4C, interface processing module 432 may provide risk data 434 and interface and layout data 436 as an input to an interface element generation module 438 of executed banking application 108. In one example, interface element generation module 438 may process risk data 434 and interface and layout data 436, and may generate and route one or more interface elements 440 to display unit 116A of client device 102, which may render interface elements 440 for presentation to user 101 within a graphical user interface (GUI) 442.

In some instances, GUI 442 may represent a digital interface generated by executed banking application 108, and as illustrated in FIG. 4D, may include interface elements 444A that identify, to user 101, the high-level of risk that characterizes the commercial customer. Further, GUI 442 may also include additional interface elements, e.g., elements 444B, that characterize the parameterized risk profile of the high-risk commercial customer, and identify one or more of the composite metric value, the temporal evolution in that composite metric value, or the total exposure value that collectively establish the high-risk status of the commercial customer. In some instances, GUI 442 may present interface elements 444A or 444B in accordance with a visual characteristic associated with the assigned level of risk, e.g., as red text associated with high-risk status of the commercial customer. In other instances, not illustrated in FIG. 4D, GUI 442 may also include one or more symbols or glyphs that enable to the user to visually perceive the high-risk status of the commercial customer, and additional, or alternate, interface elements that present an evolution in the risk profile of the high-risk customer over various temporal intervals (e.g., over a prior year) or that graphically present the parameterized risk profile within a corresponding, multidimensional risk space.

In some examples, as described herein, monitoring system 130 may perform operations that dynamically determine a level of potential risk that characterizes an interaction between a financial institution and one or more of its individual or commercial customers, and that dynamically parameterize a corresponding risk profile for each of these individual or commercial customers based not only on a current interaction between these customers and the financial institution, but on changes in that interaction over time. For instance, and using any of the processes described herein, monitoring system 130 may segment each of the individual or commercial customers into a corresponding one of the low, slight, strong, or high level of risk, and perform operations that tailor a scope and intensity scheduled review of the risk profile for each of the customers (e.g., the light, moderate, full, or in-depth reviews described herein), and that dynamically perform certain operation associated with each of the customers, in accordance with the determined low, slight, strong, or high levels of risk.

In further examples, and as described herein, monitoring system 130 may perform additional operations that process portions of the customer-specific risk levels and the customer-specific risk profiles to generate values of aggregated parameters that characterize an aggregated risk profile of the financial institution. For example, monitoring system 130 may monitor and track a number of individual or commercial customers segmented into each of the determined levels of risk, and further, may track a temporal evolution of the number of segmented customers within each determined risk level on a month-to-month basis and further, on a year-to-year basis. Monitoring system 130 may also monitor and track a number of individual or commercial customers assigned to each of the review intensities and scopes, and may track a temporal evolution of the number of assigned customers on a month-to-month basis and further, on a year-to-year basis.

In some examples, monitoring system 130 may perform operations that generate and transmit portions of the aggregated customer-specific data described herein to a network-connected device associated with an employee of agent of the financial institution, e.g., client device 122 of FIG. 1. As described herein, client device 122 may receive the aggregated customer-specific data through a secure, programmatic interface, and an application program executed by client device 122, such as monitoring application 110 of FIG. 1, may perform any of the exemplary processes described herein to render the aggregated customer-specific data for presentation within a corresponding digital interface, such as a dashboard associated with a particular unit of the financial institution (e.g., a branch of the financial institution).

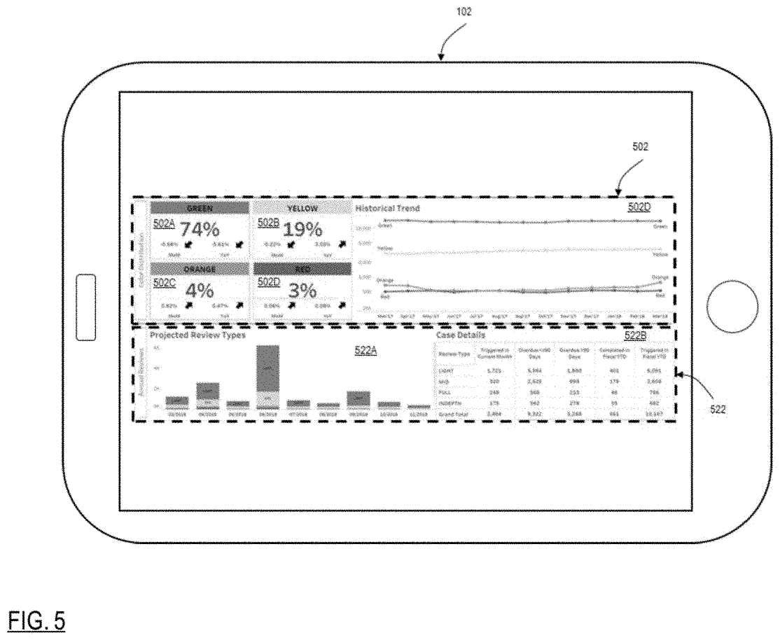

Referring to FIG. 5, executed monitoring application 110 may present the digital interface, e.g., the branch-specific dashboard 500, via a corresponding display unit of client device 122, such as display unit 116A. As illustrated in FIG. 5, dashboard 500 may include interface elements 502 that identify and characterize the segmentation of individual or commercial customers into each of the levels of potential risk described herein (e.g., low, light, strong, and high levels of potential risk derived from the provision of financial services to the customers), and interface elements 522 that identify and characterize the scope and intensity of the scheduled review for the segmented individual or commercial customers (e.g., light, moderate, full, and in-depth reviews).

In some instances, executed monitoring application 110 may assign a particular visual characteristic to each of the levels of potential risk (e.g., green being indicative of low risk, yellow being indicative of slight risk, orange being indicative of strong risk, and red being indicative of high risk) and additionally, or alternatively, to each of scope and intensity of the scheduled reviews (e.g., green being indicative of a light review, yellow being indicative of a moderate review, orange being indicative of a full review, and red being indicative of an in-depth review). The disclosed embodiments are, however, not limited to these exemplary visual characteristics, and in other instances, executed monitoring application 110 may assign any additional, or alternate, visual characteristic to the levels of potential risk or the scopes and intensities of the scheduled review within dashboard 500.

For example, interface elements 502 may include interface element 502A, which indicates that seventy-four percent of the customers are characterized as low-risk customers, and that the total number of low-risk customers declined 0.66% on a month-to-month basis and 3.61% on a year-to-year basis. As illustrated in FIG. 5, interface element 502B indicates that nineteen percent of the customers are characterized as slight-risk customers, and that the total number of slight-risk customers declined 0.22% on a month-to-month basis, but increased 3.05% on a year-to-year basis. Further, interface element 502C which indicates that four percent of the customers are characterized as strong-risk customers (e.g., representing increases of 0.82% and 0.47% on respective ones of month-to-month and year-to-year basis), and interface element 502D indicates that three percent of the customers are characterized as high-risk customers (e.g., representing increases of 0.06% and 0.08% on respective ones of month-to-month and year-to-year basis). Interface element 502E plots an evolution of in a total number of low-, slight-, strong-, and high-risk customers on a monthly basis over a prior year.

Further, as illustrated in FIG. 5, interface elements 522 may also include interface element 522A, which plots a temporal evolution in a total number of customers scheduled for a light, moderate, full, or in-depth review on a monthly basis over a prior year. Additionally, interface elements 522B provide tabulated numbers of triggered, overdue, and completed ones of the light, moderate, full, or in-depth review during not only a current month, but also through the current year. The disclosed embodiments are, however, not limited to these examples of segmented customer data and review data, and to these exemplary interface elements, and in other instances, dashboard 500 may include any additional or alternate number or type of interface elements that present any additional or alternate information to user 121.

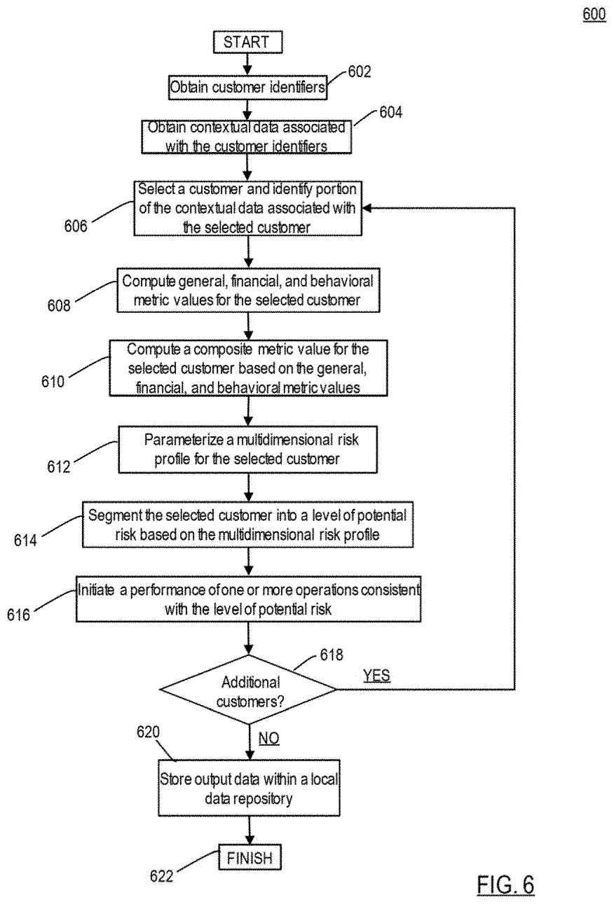

FIG. 6 is a flowchart of an exemplary process 600 for dynamically monitoring and profiling exchanges of data within an enterprise environment, in accordance with the disclosed embodiments. In some examples, a network-connected computing system, such as monitoring system 130 of FIG. 1, may perform one or more of the exemplary steps of process 600.

Referring to FIG. 6, monitoring system 130 may perform any of the exemplary processes described herein to obtain data identifying one or more counterparties to an exchange of data (e.g., in step 602). As described herein, each of the one or more counterparties may correspond to an individual or a commercial customer of a financial institution that operates monitoring system 130, and the obtained data may include corresponding unique identifiers of these individual or commercial customers. Further, and as described herein, monitoring system 130 may obtain the customer identifiers from one or more locally accessible data repositories, e.g., from customer database 132 of FIG. 1.

Based on the obtained counterparty data, monitoring system 130 may obtain contextual data that identifies and characterizes each of the counterparties and one or more data exchanges involving these counterparties (e.g., in step 604). For example, the obtained contextual data may include one or more elements of customer profile data, customer transaction data, and customer account data that characterize each of the identified customers, certain financial services provisioned to each of the identified customers, and certain transactions involving each of the customers and/or the provisioned financial services. In some instances, monitoring system 130 may obtain all or a portion of the customer profile data, customer transaction data, and customer account data from one or more locally accessible data repositories (e.g., from customer database 132, transaction database 134, and account database 135 of FIG. 1), or from one or more external computing systems across network 120, e.g., that collectively establish a distributed, cloud-based data repository.

In some instances, monitoring system 130 may select one of the identified counterparties and identify portions of the contextual data that are associated with the selected counterparty (e.g., in step 606). Monitoring system 130 may apply one or more predictive models to the identified portions of the contextual data to compute values of a plurality of metrics that, collectively, indicate a likelihood that the counterparty performs an expected exchange of data in accordance with an expected parameter value during a corresponding and future temporal interval (e.g., in step 608).

As described herein, the selected counterparty may correspond to one of the customers of the financial institution (e.g., a commercial customer), and the performance of the expected data exchange may, in some examples, facilitate a servicing of one or more existing obligations imposed on the commercial customer by the financial institution (e.g., a scheduled payment on a revolving line of credit or a loan provided to the customer by the financial institution). In some instances, the plurality of metric values computed for the commercial customer may be indicative of a risk to the financial institution that results from the provision of the financial services to that commercial customer, and each of the plurality of metric values may be associated with a correspond customer-specific risk factors, such as the general risk factor, the financial risk factor, and the behavioral risk factor described herein.

In some examples, and using any of the exemplary processes described herein, monitoring system 130 may apply, to corresponding portions of the customer profile data, customer transaction data, and customer account data, a general predictive model that predicts a general metric value characterizing the general risk factor for the commercial customer, a financial predictive model that predicts a financial metric value characterizing the financial risk factor for the commercial customer, and a behavioral predictive model that predicts a behavioral metric value characterizing the behavioral risk factor for the commercial customer (e.g., in step 608). Further, and as described herein, the general, financial, and/or behavioral predictive models may include, but are not limited to, a deterministic statistical process, a stochastic statistical process, a machine learning process, or an artificial intelligence model.

For example, the deterministic statistical processes can include, but are not limited to, an index based on certain parameter values, a linear regression model, a nonlinear regression model, a multivariable regression model, and additionally, or alternatively, a linear or nonlinear least-squares approximation. Examples of the stochastic statistical process can include, among other things, a support vector machine (SVM) model, a multiple regression algorithm, a least absolute selection shrinkage operator (LASSO) regression algorithm, or a multinomial logistic regression algorithm, and examples of the machine learning processes can include, but are not limited to, an association-rule algorithm (such as an Apriori algorithm, an Eclat algorithm_{;} or an FP-growth algorithm) or a clustering algorithm (such as a hierarchical clustering process, a k-means algorithm, or other statistical clustering algorithms). Further, examples of the artificial intelligence model include, but are not limited to, an artificial neural network model, a recurrent neural network model, a Bayesian network model, or a Markov model.

Referring back to FIG. 6, monitoring system 130 may perform any of the exemplary processes described herein to compute, for the commercial customer, a composite metric value based on a combination of the general metric value, the financial metric value, and the behavioral metric value (e.g., in step 610). As described herein, the composite metric value may reflect a risk to the financial institution that results from a provisioning of financial services to the commercial customer, and may represent a relative contribution of the generate, financial, and behavioral risk factors described herein.

Further, in some instances, monitoring system 130 may perform any of the exemplary processes described herein that parameterize a multidimensional risk profile for the commercial customer based on the composite metric value, a time evolution of the composite metric value across one or more prior temporal intervals, and additional data characterizes an interaction between the identified customers and the financial institution (e.g., in step 612). For example, the additional data may include, but is not limited to, an exposure value that characterizes an amount of credit extended to the commercial customer by the financial institution, e.g., derived from certain payment or credit instruments issued to the commercial customer by the financial institution. Based on corresponding the composite metric value, the temporal evolution in the composite metric value, and the total exposure value, monitoring system 130 may perform any of the exemplary processes described herein to segment the commercial customer of the financial institution into a corresponding level of potential risk, e.g., low risk, slight risk, strong risk, or high risk (e.g., in step 614).

In some instances, monitoring system 130 may perform any of the exemplary processes described herein to identify, and trigger an initiation of, one or more operations consistent with the level of potential risk assigned to the commercial customer of the financial institution and additionally, or alternatively, with the parameterized risk profile of the commercial customer (e.g., in step 616). As described herein, the one or more operations may include, but are not limited to, a generation and transmission of a customer-specific notification to network-connected devices or systems operated by the customers of the financial institution, employees or agents of the financial institution, and additionally, or alternatively, other business, governmental, or regulatory entities associated with the provisioned financial services (e.g., an underwriter of a commercial loan, a commercial lender, a governmental agency, etc.).

In other instances, described herein, the one or more operations may facilitate a review of the financial services provided to the commercial customer, and further, the determination of a timing, a scope, and an intensity of the review for the commercial customer (e.g., the light, moderate, full, or in-depth reviews described herein). Additionally, and as described herein, the one or more operations my also include, but are not limited to, a modification to a term associated with a provisioned payment instrument (e.g., a commercial credit card, etc.) or a provisioned credit instrument (e.g., a revolving line of credit, a commercial loan, etc.), an acceleration of a scheduled review, or an initiation of out-of-band communications by an employee of the financial institution, e.g., a telephone call, etc. The disclosed embodiments are, however, not limited to these examples of triggered operations, and in other instances, monitoring system 130 may initiate a performance of any additional or alternate operation appropriate to the determined risk level, and the parameterized risk profile, of the commercial customer.

Monitoring system 130 may further process the obtained customer data to determine whether additional individual or commercial customers await processing using any of the exemplary processes described herein (e.g., in step 618). If monitoring system 130 were to identify additional individual or commercial customers (step 618; YES), exemplary process 600 may pass back to step 606, and monitoring system 130 may select an additional one of the identified customers for processing.

Alternatively, if monitoring system 130 were to establish that none of the individual or commercial customers await processing (e.g., step 618; NO), monitoring system 130 may package the customer identifiers, the determine risk levels, and the elements of parameterized risk profile data into corresponding elements of output data, which monitoring system 130 may storing within a locally accessible data repository, such as monitoring database 136 (e.g., in step 620). Exemplary process 600 is then complete is step 622.

### III. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification, including banking application 108, monitoring application 110, predictive engine 138, initiation module 202, input processing module 206, predictive modules 215, general predictive module 216A, financial predictive module 216B, behavioral predictive module 216C, aggregation module 222, risk parameterization module 226, risk segmentation module 238, exception module 244, notification generation module 424, routing module 428, interface processing module 432, and interface element generation module 438, can be implemented as one or more computer programs, i.e., one or more modules of computer program instructions encoded on a tangible non transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a communications unit;
a storage unit storing instructions; and
at least one processor coupled to the communications unit and the storage unit, the at least one processor being configured to execute the instructions to:
obtain information associated with a first counterparty to an exchange of data, the data exchange being characterized by at least one parameter value;
based the obtained information, determine a value of a metric characterizing a probability that the first counterparty performs the data exchange in accordance with the at least one parameter value during a future temporal interval;
establish a consistency between a triggering criterion associated with the data exchange and at least one of (i) the metric value, (ii) a change in the metric value during a prior temporal interval, or (iii) interaction data that characterizes an interaction between the first counterparty and a second counterparty to the data exchange; and
in response to the established consistency, generate and transmit, via the communications unit, a first signal to a first device, the first signal comprising additional information that causes a first application program executed by the first device to present a representation of the metric value within a corresponding digital interface.

2. The apparatus of claim 1, wherein the at least one processor is further configured to:
compute a plurality of component metric values based on corresponding portions of the obtained information; and
determine the metric value based on the component metric values.

3. The apparatus of claim 2, wherein the at least one processor is further configured to:
compute a first one of the component metric values based on a first portion of the obtained information, the first portion of the obtained information comprising profile data that characterizes the first counterparty;
compute a second one of the component metric values based on a second portion of the obtained information, the second portion of the obtained information comprising parameter values that characterize one or more prior exchanges of data involving the first counterparty;
compute a third one of the component metric values based on a third portion of the obtained information that includes the interaction data; and
determine the metric value based on the first, second, and third component metric values.

4. The apparatus of claim 3, wherein the at least one processor is further configured to compute at least one of the first, second, or third component metric values based on an application of a statistical process, a machine learning process, or an artificial intelligence process to a corresponding one of the first, second, or third portions of the obtained information.

5. The apparatus of claim 1, wherein the at least one processor is further configured to compute an exposure value based on the interaction data, the exposure value characterizing one or more prior exchanges of data involving the first and second counterparties.

6. The apparatus of claim 5, wherein the at least one processor is further configured to:
obtain exception data that identifies candidate triggering criteria associated with the data exchange, each of the candidate triggering criteria being associated with a first range of candidate metric values, a second range of changes in the candidate metric values, and a third range of exposure values; and
establish that the determined metric value, the change in the determined metric value, and the exposure value are consistent with respective ones of the first range, the second range, and the third range associated with a corresponding one of the candidate triggering criteria.

7. The apparatus of claim 6, wherein the at least one processor is further configured to:
extract, from the exception data, at least one notification parameter associated with the corresponding one of the candidate triggering criteria; and
generate and transmit the first signal to the first device in accordance with the at least one notification parameter.

8. The apparatus of claim 5, wherein the at least one processor is further configured to:
determine that at least one of the metric value, the change in the metric value, or the exposure value is inconsistent with a corresponding threshold criterion; and
modify the at least one parameter value associated with the data exchange when the at least one of the metric value, the change in the metric value, or the exposure value is inconsistent with the corresponding threshold criterion.

9. The apparatus of claim 1, wherein the at least one processor is further configured to modify the at least one parameter value associated with the data exchange in response to the established consistency.

10. The apparatus of claim 1, wherein the at least one processor is further configured to generate and transmit, via the communications unit, a second signal to a second device associated with the second counterparty, the second signal comprising the additional information, the additional information causing a second application program executed by the second device to present a representation of the metric value within the corresponding digital interface.

11. The apparatus of claim 1, wherein:
the additional information identifies the triggering criterion and comprises the metric value; and
the additional information causes the executed first application program to establish a visual characteristic of the presented representation within the digital interface.

12. A computer-implemented method, comprising:
obtaining, by at least one processor, information associated with a first counterparty to an exchange of data, the data exchange being characterized by at least one parameter value;
based the obtained information, determining, by the at least one processor, a value of a metric characterizing a probability that the first counterparty performs the data exchange in accordance with the at least one parameter value during a future temporal interval;
establishing, by the at least one processor, a consistency between a triggering criterion associated with the data exchange and at least one of (i) the metric value, (ii) a change in the metric value during a prior temporal interval, or (iii) interaction data that characterizes an interaction between the first counterparty and a second counterparty to the data exchange; and
in response to the established consistency, generating and transmitting, by the at least one processor, a first signal to a first device, the first signal comprising additional information that causes a first application program executed by the first device to present a representation of the metric value within a corresponding digital interface.

13. The computer-implemented method of claim 12, further comprising:
computing a plurality of component metric values based on corresponding portions of the obtained information; and
determining the metric value based on the component metric values.

14. The computer-implemented method of claim 13, further comprising:
computing a first one of the component metric values based on a first portion of the obtained information, the first portion of the obtained information comprising profile data that characterizes the first counterparty;
computing a second one of the component metric values based on a second portion of the obtained information, the second portion of the obtained information comprising parameter values that characterize one or more prior exchanges of data involving the first counterparty;
computing a third one of the component metric values based on a third portion of the obtained information that includes the interaction data; and
determining the metric value based on the first, second, and third component metric values.

15. The computer-implemented method of claim 14, further comprising computing at least one of the first, second, or third component metric values based on an application of a statistical process, a machine learning process, or an artificial intelligence process to a corresponding one of the first, second, or third portions of the obtained information.

16. The computer-implemented method of claim 12, further comprising:
computing an exposure value based on the interaction data, the exposure value characterizing one or more prior exchanges of data involving the first and second counterparties;
obtaining exception data that identifies candidate triggering criteria associated with the data exchange, each of the candidate triggering criteria being associated with a first range of candidate metric values, a second range of changes in the candidate metric values, and a third range of exposure values; and
establishing that the determined metric value, the change in the determined metric value, and the exposure value are consistent with respective ones of the first range, the second range, and the third range associated with a corresponding one of the candidate triggering criteria.

17. The computer-implemented method of claim 16, further comprising:
extracting, from the exception data, at least one notification parameter associated with the corresponding one of the candidate triggering criteria; and
generating and transmitting the first signal to the first device in accordance with the at least one notification parameter.

18. The computer-implemented method of claim 16, further comprising:
determining that at least one of the metric value, the change in the metric value, or the exposure value is inconsistent with a corresponding threshold criterion; and
modifying the at least one parameter value associated with the data exchange when the at least one of the metric value, the change in the metric value, or the exposure value is inconsistent with the corresponding threshold criterion.

19. The computer-implemented method of claim 12, further comprising generating and transmitting a second signal to a second device associated with the second counterparty, the second signal comprising the additional information, the additional information causing a second application program executed by the second device to present a representation of the metric value within a corresponding digital interface.

20. A tangible, non-transitory computer-readable medium storing instructions that, when executed by at least one processor, cause the at least one processor to perform a method, comprising:
obtaining information associated with a first counterparty to an exchange of data, the data exchange being characterized by at least one parameter value;
based the obtained information, determining a value of a metric characterizing a probability that the first counterparty performs the data exchange in accordance with the at least one parameter value during a future temporal interval;
establishing a consistency between a triggering criterion associated with the data exchange and at least one of (i) the metric value, (ii) a change in the metric value during a prior temporal interval, or (iii) interaction data that characterizes an interaction between the first counterparty and a second counterparty to the data exchange; and
in response to the established consistency, generating and transmitting a signal to a device, the signal comprising additional information that causes an application program executed by the device to present a representation of the metric value within a corresponding digital interface.
